(19) United States
(12) Patent Application Publication
(10) Pub. No.: US 2007/0085805 A1
(43) Pub. Date: Apr. 19, 2007

(54) ELECTRO-OPTICAL DEVICE AND ELECTRONIC APPARATUS

(75) Inventors: Tatsuya Ishii, Suwa-shi, Nagano-ken (JP); Keiji Fukuhara, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/538,597

(22) Filed: Oct. 4, 2006

(30) Foreign Application Priority Data
Oct. 18, 2005 (JP) 2005-302784

(51) Int. Cl. G09G 3/36

(52) U.S. Cl. 345/98

(57) ABSTRACT

An electro-optical device includes a pair of a first substrate and a second substrate between which an electro-optical material is held, a first electrode formed in each of a plurality of pixel portions disposed in an pixel area on one of the first substrate and the second substrate, a first pixel circuit formed in the pixel portion on the one of the first substrate and the second substrate and including a first active element that controls the first electrode, a second electrode formed in each of the plurality of pixel portions disposed in the pixel area on the one of the first substrate and the second substrate or the other one of the first substrate and the second substrate, the second electrode being formed in association with the first electrode, and a second pixel circuit formed in the pixel portion on one of the first substrate and the second substrate or the other one of the first substrate and the second substrate and including a second active element that controls the corresponding second electrode, the second pixel circuit being formed in association with the second electrode.

### BACKGROUND

1. Technical Field

The present invention relates to an electro-optical device, such as a liquid crystal device, and an electronic apparatus, such as a liquid crystal projector, including the electro-optical device.

2. Related Art

In this type of electro-optical device, a liquid crystal, which is one type of electro-optical material, is held between a pair of substrates, i.e., an element substrate and a counter substrate, as disclosed in JP-A-2005-107548. On the element substrate, in a pixel area or a pixel array area in which a plurality of pixels are disposed, a plurality of pixel portions including pixel electrodes are formed at the intersections of scanning lines and data lines in a matrix.

Each pixel portion includes a pixel switching element, for example, a thin-film transistor (TFT). When the electro-optical device is driven, in each pixel portion, a scanning signal is supplied from the corresponding scanning line to turn ON the pixel switching element, and then, an image signal is supplied to the pixel electrode from the corresponding data line through the pixel switching element.

On the surface of the counter substrate facing the element substrate, typically, a counter electrode used in common for all the pixel portions is formed in substantially the entire pixel area. When the electro-optical device is driven, the counter electrode is maintained at a predetermined potential, and in each pixel portion, a voltage based on the potential difference between the pixel electrode and the counter electrode is applied to the liquid crystal. In this case, the image signal is supplied to the pixel electrode by being inverted to the positive polarity or the negative polarity with respect to the reference potential, and also, the counter electrode is driven so that the polarity thereof is inverted to the polarity different from the potential of the image signal with respect to the reference potential in synchronization with the polarity inversion of the image signal. Such a drive method is one type of known inversion driving and is sometimes referred to as the “common-electrode (counter-electrode)-potential switching driving”.

More specifically, according to the common-electrode-potential switching driving, so-called “line inversion driving” is performed. In this driving, pixel electrodes disposed in the same row along a scanning line are driven with a potential having the same polarity while pixel electrodes disposed in adjacent rows are driven with a polarity having the polarity opposite to the polarity of the pixel electrodes in the adjacent row. In this case, the potential polarity is inverted line by line in a cycle of every frame or field (i.e., one vertical period cycle or one vertical scanning cycle),. Alternatively, so-called “frame inversion driving” is performed. In this driving, a plurality of pixel portions in an image area are driven with a potential having the same polarity, and the potential polarity is inverted in a cycle of every vertical period. In this frame inversion driving, the potential of the pixel electrode is sequentially inverted line by line, as in the line inversion driving.

According to the above-described type of electro-optical device, however, if, during manufacturing, any fault occurs in a pixel portion, and more specifically, in an electrical path between a pixel electrode and a scanning line or a data line through a pixel switching element, causing a point defect, and thus, the manufacturing yield is decreased.

In the above-described common-electrode-potential switching driving, when inverting the polarity of the potential of the counter electrode, a large amount of current is required for charging and discharging the counter electrode. Accordingly, it becomes difficult to drive the counter electrode at high speed. This makes the potential of the counter electrode unstable, which further makes it difficult to stably apply a voltage based on an image signal to the liquid crystal in each pixel portion.

The polarity inversion timing of the potential of the counter electrode is different from that of the pixel electrode in each pixel portion. Accordingly, in each pixel portion, in accordance with a change in the potential of the counter electrode, so-called “push-up” occurs in which the potential of the pixel electrode controlled by the pixel switching element is increased, or conversely, so-called “push-down” occurs in which the potential of the pixel electrode controlled by the pixel switching element is decreased. Thus, in each pixel portion, it is necessary to increase characteristics of the pixel portions, such as the source-drain breakdown voltage characteristic and the OFF-state current characteristic of the pixel switching elements. As a result, since a sufficient area for forming the pixel switching element should be ensured in each pixel portion, the miniaturization of pixel portions becomes difficult, and also, the aperture ratio is reduced. The aperture ratio is the ratio of the area of the aperture to the entire area (including the aperture area and the non-aperture area other than the aperture area) of each pixel.

Additionally, in each pixel portion, due to the leakage of light through the aperture area, a light leakage current may be generated in the pixel switching TPTs disposed in the non-aperture area. In this case, because of the property of the TFTS, the level of light leakage becomes different between when the pixel electrode is driven with a potential having the positive polarity and when the pixel electrode is driven with a potential having the negative polarity. Accordingly, the voltage applied to the electro-optical material changes between when the pixel electrode is driven with a potential having the positive polarity and when the pixel electrode is driven with a potential having the negative polarity, and such a voltage change is not negligible. Thus, flickering in response to the inversion driving cycle occurs, and as a result, the image quality is deteriorated.

### SUMMARY

An advantage of the invention is that it provides an electro-optical device that can display high-quality images while improving the manufacturing yield and also provides an electronic apparatus including such an electro-optical device.

According to an aspect of the invention, there is provided an electro-optical device including a pair of a first substrate and a second substrate between which an electro-optical material is held, a first electrode formed in each of a plurality of pixel portions disposed in an pixel area on one of the first substrate and the second substrate, a first pixel circuit formed in the pixel portion on the one of the first substrate and the second substrate and including a first active element that controls the first electrode, a second electrode formed in each of the plurality of pixel portions disposed in the pixel area on the one of the first substrate and the second substrate or the other one of the first substrate and the second substrate, the second electrode being formed in association with the first electrode, and a second pixel circuit formed in the pixel portion on one of the first substrate and the second substrate or the other one of the first substrate and the second substrate and including a second active element that controls the corresponding second electrode, the second pixel circuit being formed in association with the second electrode.

In the aforementioned electro-optical device, the first substrate and the second substrate are disposed facing each other with an electro-optical material, for example, a liquid crystal, therebetween. On the surface of each of the first substrate and the second substrate that faces the other substrate, a plurality of pixel portions are disposed in a predetermined pattern in the pixel area. In each pixel portion, the first electrode and the first pixel circuit for driving the first electrode are formed on one of the first substrate and the second substrate. The first pixel circuit includes a first active element, for example, a TFT, and the first electrode is driven by being controlled by the first active element and is set to be a predetermined potential.

In each pixel portion, the second electrode is formed in association with the first electrode. The second electrodes may be formed on the substrate on which the first electrodes are formed, or may be formed on the other substrate.

In each pixel portion, the second pixel circuit for driving the second electrode is formed. The second pixel circuits are formed on the substrate on which the second electrodes are formed. Each second pixel circuit includes a second active element, for example, a TFT, and the second electrode is driven by being controlled by the second active element and is set to be a predetermined potential.

The second pixel circuit may have the function of replacing the first pixel circuit, and additionally or alternatively, the second pixel circuit may be formed on the substrate different from the substrate on which the second electrode is formed so that the first electrode and the second electrode can be driven individually for each pixel.

When driving the electro-optical device, in each pixel portion, the voltage corresponding to the potential difference between the first electrode and the second electrode is applied to the electro-optical material in accordance with image data to be displayed in each pixel, so that images can be displayed. If the first electrodes and the second electrodes are formed on the different substrates, electric fields that direct perpendicularly to the substrate surfaces, so-called “vertical electric fields”, are generated due to the potential difference between the first electrode and the second electrode, and the voltage corresponding to the image data is applied to the electro-optical material. Conversely, if the first electrodes and the second electrodes are formed on the same substrate, electric fields that direct parallel with the substrate surfaces, so-called “horizontal electric fields”, are generated due to the potential difference between the first electrode and the second electrode, and the voltage corresponding to the image data is applied to the electro-optical material. Regardless of whether the vertical electric fields or the horizontal electric fields are generated, a liquid crystal holding capacitor is formed between the first electrode and the second electrode in the liquid crystal held therebetween as the electro-optical material.

Accordingly, in the aforementioned electro-optical device, in the plurality of pixel portions in the pixel area, the first electrodes can be driven independently of each other by the first pixel circuits, and the second electrodes are driven independently of each other by the second pixel circuits.

During the manufacturing of the electro-optical device, if a fault occurs in the first pixel circuit, the potential of the second electrode can be adjusted by the corresponding second pixel circuit. Thus, in each pixel portion, the second pixel circuit can replace the first pixel circuit in which a fault has occurred. That is, the second pixel circuit can serve as a redundancy circuit. Thus, the problem of the reduced manufacturing yield can be solved.

In the aforementioned electro-optical device, in each pixel portion, inversion driving similar to the common-electrode-potential switching driving may be performed. More specifically, in each pixel portion, the potential of the first electrode is inverted to the positive polarity or the negative polarity with respect to a reference potential in a predetermined cycle, and the potential of the second electrode is inverted to the positive polarity or the negative polarity, which is opposite to the polarity of the first electrode, in synchronization with the inversion cycle of the polarity of the first electrode. In this case, the current for driving each of the first electrode and the second electrode becomes considerably smaller than the current required for driving the counter electrode in the common-electrode-potential switching driving. Accordingly, the potentials of the first electrodes and the second electrodes can be easily stabilized, and the pixel portions can be driven at high speed.

The synchronization of the polarity inversion of the first electrode and the second electrode can be controlled individually for each pixel portion 70. Accordingly, in a pixel which is not being selected, the potential of one of the first electrode and the second electrode is not pushed up or pushed down since the potential of the other electrode is not fluctuated. Thus, if at least one of the first active element of the first pixel circuit and the second active element of the second pixel circuit is formed of a TFT, a TFT having a smaller source-drain breakdown voltage can be used, unlike in the common-electrode-potential switching driving. Alternatively, the OFF-state current characteristic demanded for the TFT can be relatively small. That is, the transistor characteristics demanded for a TFT, such as the device characteristics demanded for the first active element and the second active element, can be relatively small. Accordingly, in each pixel portion, the area where both the first active element and the second active element are formed can be made smaller, and three miniaturization of the pixel portions can be enhanced and the aperture ratio is also increased. As a result, in the electro-optical device, the luminance can be enhanced by utilizing light more efficiently, and also, high-definition image display can be implemented.

Additionally, in each pixel portion, both the first active element and the second active element are formed of TFTs. In this case, when driving the first electrode and the second electrode by polarity inversion, the level of light leakage occurring in the first active element is substantially equivalent to that occurring in the second active element. As a result, it is possible to suppress considerable changes in the voltage applied to the electro-optical material caused by the polarity inversion of the first electrode and the second electrode. Thus, flickering occurring in response to the inversion driving cycle can be prevented.

Accordingly, the manufacturing yield can be improved, and high-quality image display can be achieved.

In addition to or as an alternative to the inversion driving similar to the common-electrode-potential switching driving, the following modification may be made. In each pixel portion, one of the potential of the first electrode and the second electrode may be fixed at a predetermined value, and in a predetermined cycle, the potential of the other electrode may be inverted to the positive polarity or the negative polarity with respect to a reference potential. In this case, compared with the configuration in which a counter electrode is formed in common for all pixel portions on the counter substrate, the potentials of the first electrodes and the second electrodes can be stabilized, and the pixel portions can be driven at high speed.

It is preferable that the electro-optical device may further include a signal supply circuit that outputs a first signal to be supplied to the first electrode and also outputs a second signal to be supplied to the second electrode.

With this arrangement, when driving the electro-optical device, in each pixel portion, the first pixel circuit is driven based on the first signal so that the first electrode is individually driven, and the second pixel circuit is driven based on the second signal so that the second electrode is individually driven. Accordingly, the potential of the first electrode and the potential of the second electrode can be adjusted by the first signal and the second signal, respectively, individually for each pixel. Portion, and the voltage based on the potential difference between the first electrode and the second electrode to be applied to the electro-optical material can be adjusted. As a result, in the pixel area of the electro-optical device, the flexibility to drive each pixel portion can be increased compared with the configuration in which the counter electrode formed in common for all pixel portions is driven by the common potential.

At least part of the signal supply circuit may be attached to the first substrate or the second substrate as an external IC, or may be integrated onto the substrate.

It is preferable that the electro-optical device may further include a defective information storage unit that stores defective pixel data indicating a defective pixel portion among the plurality of pixel portions disposed in the pixel area. In this case, the signal supply circuit may adjust the second signal on the basis of the defective pixel data stored in the defective information storage unit and supplies the adjusted second signal to the second pixel circuit so that a voltage between the first electrode and the second electrode in the defective pixel portion is adjusted.

With this configuration, address information indicating, among a plurality of pixel portions disposed in a predetermined pattern, the position of a defective pixel portion in which a fault has occurred during the manufacturing of the electro-optical device in the pixel area is stored in the defective information storage unit as defective pixel data.

In the defective pixel portion, in the case of the occurrence of a fault in the first pixel circuit, the first electrode is fixed at a predetermined voltage when being driven. In this case, the signal supply circuit adjusts the second signal to correct the voltage between the first electrode and the second electrode in the defective pixel portion so that the potential difference between the first electrode and the second electrode can represent image data to be displayed in the defective pixel portion. Then, the second pixel circuit in the defective pixel portion is driven. In this manner, by adjusting the potential of the second electrode, the potential difference between the first electrode and the second electrode can be adjusted to the image data to be displayed in the defective pixel portion.

Accordingly, in each pixel portion, the second pixel circuit has the function of replacing the first pixel circuit in which a fault has occurred.

It is thus preferable that the signal supply circuit may supply the adjusted second signal to the second pixel circuit in the defective pixel portion by replacing a potential of the second signal with a potential of the first signal.

Thus, the defective information storage unit can be configured simply. For example, fuses can be arranged on one of the first substrate and the second substrate, and the positions of the pixel portions formed in the pixel area are represented by the arrangement of the fuses. Then, the fuse indicating the position of a defective pixel portion is cut off with a laser so that the defective pixel data is stored in the defective information storage unit. In this case, instead of the second signal, the first signal is supplied to the defective pixel portion so that the second pixel circuit is driven.

As described above, countermeasures against defective pixel portions can be taken by the use of software when driving the electro-optical device. Alternatively, countermeasures may be taken by the use of hardware. More specifically, before shipping the electro-optical device, the wiring path to the first pixel circuit may be replaced with the wiring path to the second pixel circuit so that the wiring pattern in defective pixel portions can be physically changed. To form the defective information storage unit, a non-volatile semiconductor memory may be used instead of the arrangement of fuses.

It is preferable that the first electrode may be set to be a potential of the positive polarity or the negative polarity with respect to a reference potential by the first signal, and that the second electrode may be set to be a potential of the polarity opposite to the polarity of the first electrode by the second signal.

With this configuration, in each pixel portion, driving similar to the common-electrode-potential switching driving can be performed. In this case, in each pixel portion, the current for driving each of the first electrode and the second electrode can be made smaller than the current required for driving the counter electrode in the common-electrode-potential switching driving.

It is preferable that the second electrode may be formed on the other one of the first substrate and the second substrate.

With this configuration, when driving the electro-optical device, in each pixel portion, a liquid crystal holding capacitor is formed between the first electrode on the first substrate and the second electrode on the second substrate that face each other, and also, vertical electric fields are preferentially generated, and the voltage can be applied to the liquid crystal, which is one type of electro-optical material.

When driving similar to the common-electrode-potential switching driving, the synchronization of the polarity inversion between the first electrode and the second electrode can be provided individually for each pixel portion. Accordingly, the potential of each of the first electrode and the second electrode is not pushed up or pushed doom since the potential of the other electrode is not fluctuated.

It is preferable that the second pixel circuit may be formed on the other one of the first substrate and the second substrate.

With this configuration, in each pixel portion, the second pixel circuit is formed on the substrate different from the substrate on which the first pixel circuit is formed so that the sizes of the first substrate and the second substrate do not become large. Thus, the miniaturization of the pixel portions can be enhanced, and the aperture ratio can also be increased. In particular, it is possible that the same or similar configuration of the circuit and the wiring patterns be formed on the first substrate and on the second substrate, thereby facilitating the manufacturing process.

In the configuration in which the second electrode or the second pixel circuit is formed on the substrate different from the substrate on which the first pixel circuit is formed it is preferable that the electro-optical device may further include a first storage capacitor electrically connected to the first pixel electrode on the one of the first substrate and the second substrate and a second storage capacitor electrically connected to the second pixel electrode on the other one of the first substrate and the second substrate. In this case, the second storage capacitor, the second electrode, and the second pixel circuit may be formed on the other one of the first substrate and the second substrate.

With this configuration, a storage capacitor is provided on each of the first substrate and the second substrate so that the electric-charge holding characteristic in the first electrode and the second electrode can be significantly enhanced. It is also possible to construct the electro-optical device by using the first substrate and the second substrate, each being provided with an identical or similar storage capacitor, electrode, and pixel circuit. As a result, the manufacturing process can further be facilitated.

It is preferable that at least one of the first active element and the second active element may include a TFT.

Accordingly, in each pixel portion, when performing driving similar to the common-electrode-potential switching driving by preferentially generating vertical electric fields, the source-drain breakdown voltage can be decreased for at least one of the first active element and the second active element formed of a TFT. Alternatively, a TFT having a smaller source-drain breakdown voltage or a TFT having a lower OFF-state current characteristic can be used. Additionally, the level of light leakage occurring in the first active element is substantially equivalent to that occurring in the second active element. As a result, flickering in response to the inversion driving cycle can be efficiently reduced.

According to another aspect of the invention, there is provided an electronic apparatus including the above-described electro-optical device (including various modifications thereof).

Examples of the electronic apparatus include televisions, cellular telephones, electronic organizers, word-processors, view-finder-type or monitor-direct-view-type video recorders, workstations, videophones, point-of-sale (POS) terminals, and touch panels. Such electronic apparatuses can improve the manufacturing yield and implements high-quality image display.

The above-described operations and further features and advantages of the invention will become apparent from the following description of exemplary embodiments.

### BRIEF DESCRIPTION OF THE DRAWINGS

The invention will be described with reference to the accompanying drawings, wherein like numbers reference like elements.

FIG. 1 is a plan view illustrating the schematic configuration of a liquid crystal panel on a first substrate.

FIG. 2 is a sectional view taken along line II-II in FIG. 1.

FIG. 3 is a block diagram illustrating the overall configuration of a liquid crystal device.

FIG. 4 is a block diagram illustrating the electrical configuration of the elements disposed on the first substrate.

FIG. 5 is a block diagram illustrating the electrical configuration of the elements disposed on a second substrate of the liquid crystal panel.

FIG. 6 illustrates the electrical configuration of the second substrate.

FIG. 7 is a timing chart illustrating temporal changes in various signals for operating the liquid crystal device.

FIG. 8 schematically illustrates the configuration and operation of a defective information storage unit.

FIG. 9 is a plan view illustrating the schematic configuration of a liquid crystal panel of a comparative example.

FIG. 10 is a sectional view taken along line X-X in FIG. 9.

FIG. 11 illustrates the electrical configuration of a certain pixel portion of the comparative example.

FIG. 12 is a block diagram illustrating the overall configuration of a liquid crystal device of a modified example.

FIG. 13 is a timing chart illustrating temporal changes in various signals for operating a liquid crystal device in a second embodiment.

FIGS. 14A and 14B are schematic diagrams illustrating line inversion driving.

FIG. 15 is a timing chart illustrating temporal changes in the potentials of a first electrode and a second electrode during one vertical period cycle.

FIGS. 16A through 16D illustrate schematic diagrams illustrating frame inversion driving.

FIG. 17 is a waveform diagram illustrating a first image signal and a second image signal according to another type of polarity inversion driving.

FIG. 18 is a plan view illustrating the configuration of a projector, which is an example of an electronic apparatus using the electro-optical device.

FIG. 19 is a perspective view illustrating the configuration of a personal computer, which is another example of an electronic apparatus using the electro-optical device.

FIG. 20 is a perspective view illustrating the configuration of a cellular telephone, which is another example of an electronic apparatus using the electro-optical device.

### DESCRIPTION OF EXEMPLARY EMBODIMENTS

Preferred embodiments of the invention are described below with reference to the accompanying drawings. In the following embodiments, an electro-optical device is described in the context of a liquid crystal device.

First Embodiment

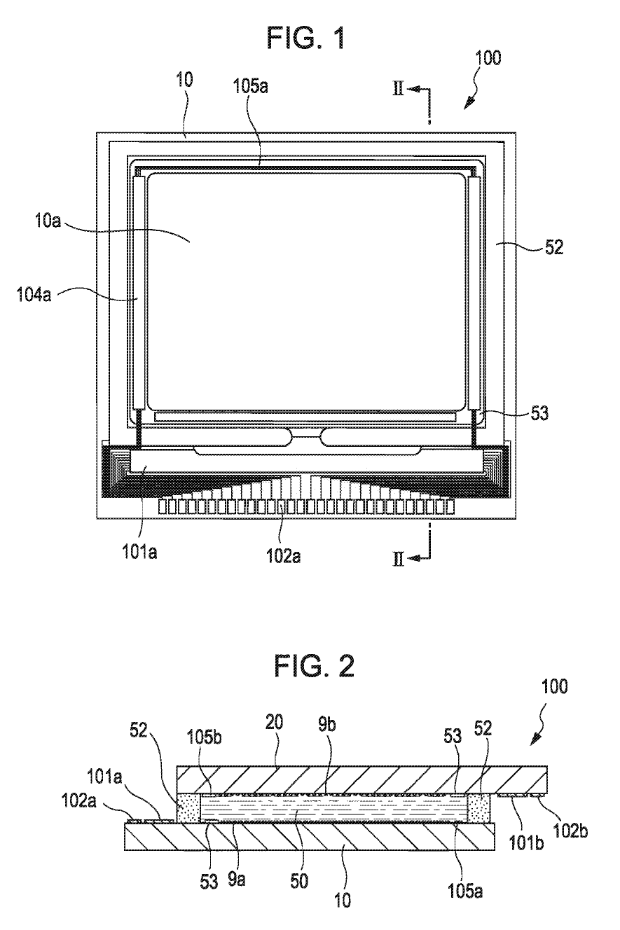

An electro-optical device according to a first embodiment of the invention is described below with reference to FIGS. 1 through 12. Overall Configuration of Electro-optical Panel

The overall configuration of a liquid crystal panel 100 which is an example of an electro-optical panel, used in a liquid crystal device, which is an example of the electro-optical device of the invention, is described below with reference to FIGS. 1 and 2. FIG. 1 is a plan view illustrating a first substrate 10, together with components formed thereon, when viewed from a second substrate 20 (see FIG. 2). For the convenience of description, the second substrate 20 is not shown in FIG. 1. FIG. 2 is a sectional view taken along line II-II in FIG. 1 and illustrates the first substrate 19 and the second substrate 20. The liquid crystal device in this embodiment is a TFT active matrix drive liquid crystal device having built-in drive circuits by way of example.

In FIGS. 1 and 2, in the liquid crystal panel 100 according to the first embodiment, the first substrate 10 and the second substrate 20 are disposed opposite each other. A liquid crystal layer 50 is sealed between the first substrate 10 and the second substrate 20. The first substrate 10 and the second substrate 20 are attached to each other by a sealing member 52 disposed in a sealing area which is located around an image display area 10a, which serves as a pixel area. That is, the liquid crystal layer 50 is sealed in the area surrounded by the sealing member 52 between the first substrate 10 and the second substrate 20.

The sealing member 52, which is composed of a ultraviolet curable resin or a thermosetting resin, is applied onto the first substrate 10 or the second substrate 20 in the manufacturing process and is then cured by ultraviolet irradiation or heating, respectively. A gap member, such as glass fiber or glass bead, is dispersed in the sealing member 52 so that the spacing (gap) between the first substrate 10 and the second substrate 20 is set to be a predetermined value.

A frame-like light-shielding film 53 is disposed in parallel with and along the inner periphery of the sealing area in which the sealing member 52 is disposed. The frame-like light-shielding film 53 is formed of a light-shielding film of a predetermined pattern disposed on each of the first substrate 10 and the second substrate 20, and defines the frame-like region of the image display area 10a. The frame-like light-shielding film 53 may be disposed on only one of the first substrate 10 and the second substrate 20 as an integrated light-shielding film.

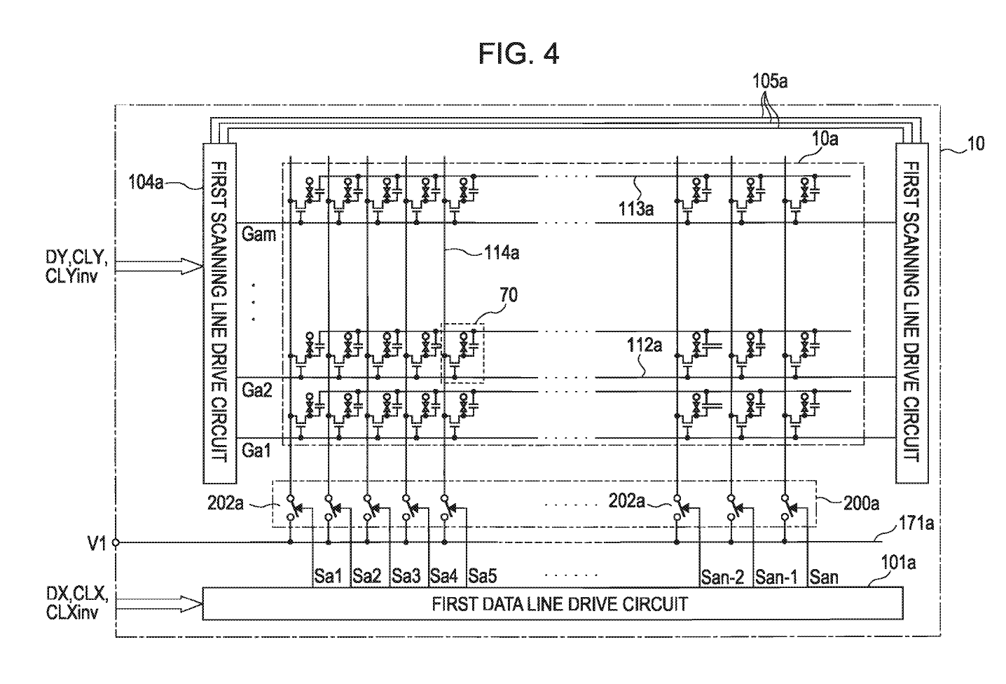

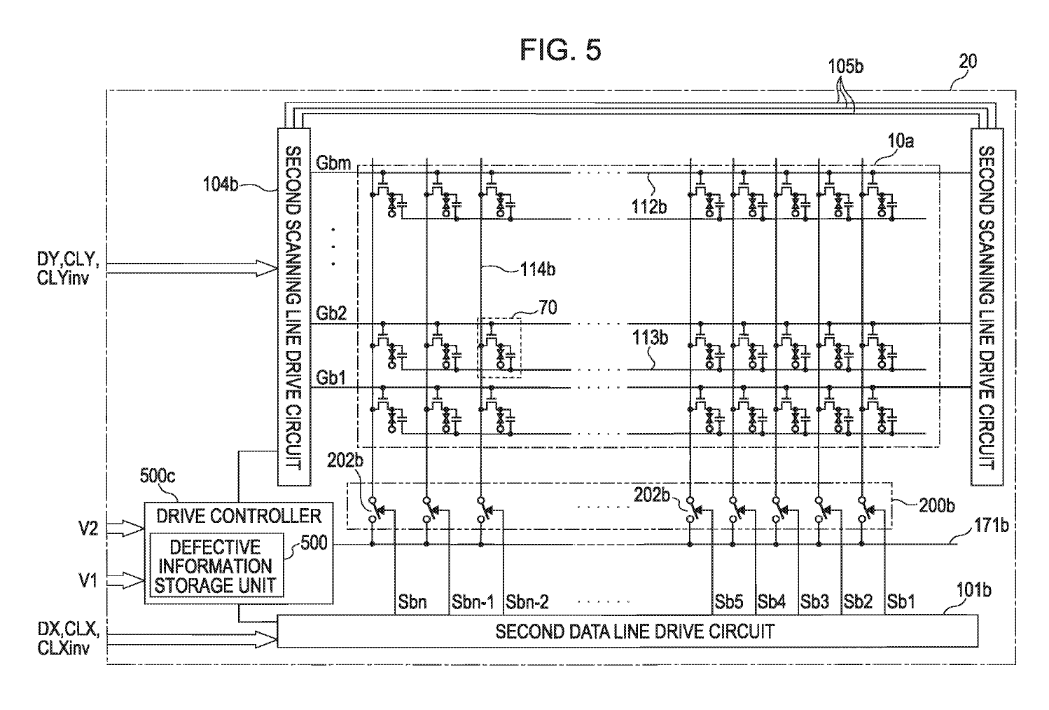

In this embodiment, on the first substrate 10, in the area around the sealing area in which the sealing member 52 is disposed, a first data line drive circuit 101a and a first external circuit connecting terminal 102a are disposed along one side of the first substrate 10. Although it is not shown in FIG. 1 or 2, a first sampling circuit 200a (see FIG. 4), which is discussed below, is disposed farther inward than the sealing area along the side on which the first data line drive circuit 101a and the first external circuit connecting terminal 102a are disposed, and is covered with the frame-like light-shielding film 53 when viewed from the top of the substrate 10. On the second substrate 20, a drive controller 50c including a defective information storage unit 500 (see FIG. 5) is disposed as one of the peripheral circuits.

First scanning line drive circuits 104a disposed on the first substrate 10 are located inward of the sealing area along the two sides adjacent to the side on which the first data line drive circuit 101a and the first external circuit connecting terminal 102a are disposed. The first scanning line drive circuits 104a are disposed such that they are covered with the frame-like light-shielding film 53 when viewed from the top of the substrate 10. To electrically connect the two first scanning line drive circuits 104a, each being disposed on either side of the image display area 10a, a plurality of wiring patterns 105a are disposed along the remaining side of the first substrate 10 such that they are covered with the frame-like light-shielding film 53.

As in the first substrate 10, a second data line drive circuit 101b and a second external circuit connecting terminal 102b are disposed at the periphery of the second substrate 20, and a second sampling circuit 200b, which is discussed below, is also provided. Additionally, as in the first substrate 10, two scanning line drive circuits 104b, each being disposed on either side of the image display area 10a, are provided at the periphery of the second substrate 20, and the two second scanning line drive circuits 104b are also electrically connected to each other by a plurality of wiring patterns 105b.

The configurations of the peripheral circuits, such as the first data line drive circuit 101a and the first scanning line drive circuits 104a, formed on the first substrate 10 are similar to the counterparts formed on the second substrate 20. Additionally, the configuration of the image display area 10a on the first substrate 10 and that on the second substrate 20 are preferably similar to each other. In the state in which the first substrate 10 and the second substrate 20 oppose each other, as shown in FIG. 2, the configuration of the pixel portions on the first substrate 10 is preferably mirror-symmetrical with that of the pixel portions on the second substrate 20. Also, for example, when viewed from the first substrate 10, the second data line drive circuit 101b and the second external circuit connecting terminal 102b of the second substrate 20 are disposed opposite the first data line drive circuit 101a and the first external circuit connecting terminal 102a of the first substrate 10 across the image display area 10a. Upper and lower conductor terminals and upper and lower conductor members (not shown) are provided on the first substrate 10 or the second substrate 20 so that electrical connection can be established therebetween. Various signals may be independently supplied to the second substrate 20 from the first external circuit connecting terminal 102a via the second external circuit connecting terminal 102b. Alternatively, some signals may be supplied to the second substrate 20 from the first external circuit connecting terminal 102a via the upper and lower conductor members. Alternatively, some signals generated on the first substrate 10 may be supplied to the second substrate 20 via the upper and lower conductor members.

In the liquid crystal panel 100 of this embodiment, on the first substrate 10, as shown in FIG. 2, a TFT, which serves as a first active element, is formed for each pixel portion, and a laminated structure integrating such TFTs and various wiring patterns, such as first scanning lines and the first data lines, is formed. First electrodes 9a are then formed on the laminated structure, and an alignment film is formed on a layer higher than the first electrodes 9a. As in the first substrate 10, on the second substrate 20, a laminated structure integrating TFTS, which serve as second active elements, second scanning lines, and second data lines, is formed, and second electrodes 9b are formed on the laminated structure. Then, an alignment film is formed on a layer higher than the second electrodes 9b. The liquid crystal layer 50 includes, for example, one type of nematic liquid crystal or a mixture of a plurality of types of nematic liquid crystal, and forms a predetermined alignment condition between a pair of alignment films. On at least one of the first substrate 10 and the second substrate 20, the non-aperture area of each pixel portion, or rather the aperture area of each pixel portion, is defined by, for example, the scanning lines and the data lines integrated into the laminated structure.

On the first substrate 10 or the second substrate 20, as the peripheral circuits, in addition to the first data line drive circuit 101a or the second data line drive circuit 101b, a precharge circuit for supplying a precharge signal having a predetermined voltage level to each data line before the supply of an image signal, and an inspection circuit for checking the quality or checking for defects of the liquid crystal devices while being manufactured or those when being shipped, may be formed, though such peripheral circuits are not shown in FIG. 1 or 2.

Overall Configuration of Electro-optical Device

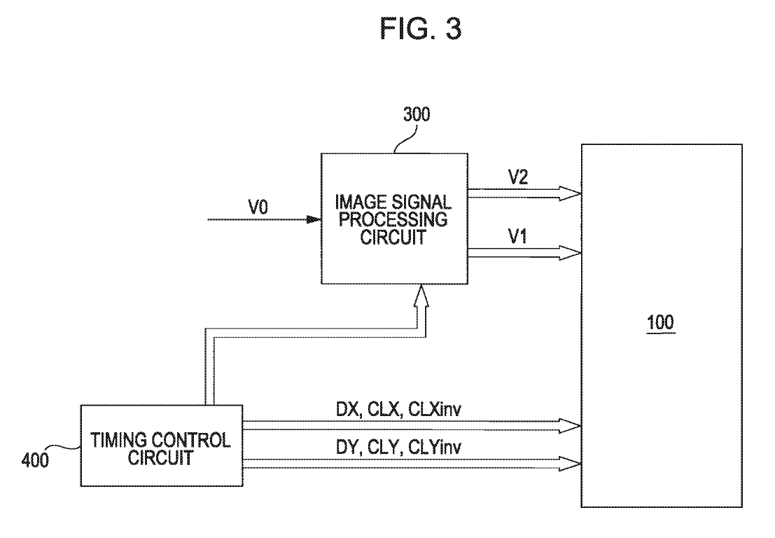

The overall configuration of the liquid crystal device, which is an example of the electro-optical device of this embodiment, is described below with reference to FIGS. 3 through 6. FIG. 3 is a block diagram illustrating the overall configuration of the liquid crystal device, FIG. 4 is a block diagram illustrating the electrical configuration of the elements disposed on the first substrate 10, and FIG. 5 is a block diagram illustrating the electrical configuration of the elements disposed on the second substrate 20.

The liquid crystal device includes, as shown in FIG. 3, the liquid crystal panel 100, and also includes an image signal processing circuit 300 and a timing control circuit 400 as peripheral circuits. In this embodiment, in addition to the first and second data line drive circuits 101a and 101b, the first and second scanning line drive circuits 104a and 104b, and the first and second sampling circuits 200a and 200b, which are peripheral circuits built in the liquid crystal panel 100, the image signal processing circuit 300 and the timing control circuit 400 are included as part of a signal supply circuit. As discussed above, the entirety or part of the signal supply circuit may be integrated in the liquid crystal panel 100. Alternatively, the entirety of the signal supply circuit may be attached to the liquid crystal panel 100 as an external circuit.

The timing control circuit 400 outputs various timing signals for driving the liquid crystal panel 100. A timing signal output unit, which is part of the timing control circuit 400, generates a dot clock, which is the minimum until for scanning a pixel, and generates a Y clock signal CLY, an inverted Y clock signal CLYinv, an X clock signal CLX, an inverted X clock signal XCLinv, a Y start pulse DY, and an X start pulse DX on the basis of the dot clock.

Upon receiving image data V0 input from an external source, the image signal processing circuit 300 generates a first image signal V1, which serves as a first signal, to be supplied to the first electrode 9a in each pixel portion, and a second image signal V2, which serves as a second signal, to be supplied to the second electrode 9b. In the image signal processing circuit 300, for example, input image data VID is subjected to serial-to-parallel conversion so that the first image signal V1 and the second image signal V2 are expanded into 6, 12, . . . , parallel signals. In the image signal processing circuit 300, the first image signal V1 and the second image signal V2 may be output while the voltage thereof is being inverted to the positive polarity or the negative polarity with respect to a predetermined reference potential

The electrical configuration of the liquid crystal panel 100 is discussed below with reference to FIGS. 4 and

Reference is first made to FIG. 4 to discuss the configuration of the surface of the first substrate 10 of the liquid crystal panel 100 that faces the second substrate 20 when viewed from the second substrate 20. As stated above, internal drive circuits including the first scanning line drive circuits 104a, the first data line drive circuit 101a, and the first sampling circuit 200a are disposed on the first substrate 10 as the peripheral circuits.

A Y clock signal CLY, an inverted Y clock signal CLYinv, and a Y start pulse DY are supplied to the first scanning line drive circuits 104a. Upon receiving the Y start pulse DY, the first scanning line drive circuits 104a sequentially generate first scanning signals Ga1, Ga2, . . . , and Gam on the basis of the Y clock signal CLY and the inverted Y signal CLYinv.

An X clock signal CLX, an inverted X clock signal CLXinv, and an X start pulse DX are supplied to the first data line drive circuit 101a. Upon receiving the X start pulse DX, the first data line drive circuit 101a sequentially generates first sampling signals Sa1, Sa2, . . . , San−2, San−1, and San on the basis of the X clock signal CLX and the inverted X signal CLXinv.

The first sampling circuit 200a includes a plurality of first sampling switches 202a formed of P-channel or N-channel TFTs or complementary TFTs.

In the image display area 10a disposed at the central portion of the first substrate 10, first data lines 114a and first scanning lines 112a are disposed vertically and horizontally, respectively, and a plurality of pixel portions 70 are disposed in a matrix at the intersections of the corresponding first data lines 114a and first scanning lines 112a. In this embodiment, a description is given, assuming that the total number of first scanning lines 112a is m (m is a two or greater natural number) and the total number of first data lines 114a is n (n is a two or greater natural number).

The first image signal V1 generated by the image signal processing circuit 300 is supplied to an image signal line 171a on the first substrate 10. As discussed above, if the first image signal V1 is expanded into 6, 12, . . . , parallel signals by the image signal processing circuit 30n by serial-parallel conversion, a plurality of image signal lines 171a corresponding to the number of expanded first image signals V1 are formed. The 6, 12, . . . , first image signals V1 are simultaneously supplied to the 6, 12, . . . , first data lines 114a via the first sampling circuit 200a. Accordingly, the first image signals V1 can be input into the first data lines 114a by groups so that the drive frequency can be suppressed. For simple representation, only one image signal line 171a is shown in FIG. 4, and a detailed configuration related to the supply of expanded image signals V1 is not shown in FIG. 4.

The first sampling signals Sa1 (i=1, 2, . . . , and n) output from the first data line drive circuit 101a are sequentially supplied to the first sampling switches 202a of the first sampling circuit 200a to turn ON the first sampling switches 202a in accordance with the first sampling signals Sai. The first image signal V1 is supplied to the first data lines 114a from the image signal line 171a via the first sampling switches 202a that are turned ON. The first scanning signals Ga1, Ga2, . . . , and Gam output from the first scanning line drive circuits 104a line-sequentially select the first scanning lines 112a.

The configuration of the surface of the second substrate 20 of the liquid crystal panel 100 that faces the first substrate 10 is described below with reference to FIG. 5. Among the peripheral circuits on the second substrate 20, the configurations of the second scanning line drive circuits 104b, the second data line drive circuit 101b, and the second sampling circuit 200b are similar to those of the first scanning line drive circuits 104a, the first data line drive circuit 101a, and the first sampling circuit 200a, respectively.

As stated above, the configuration of the image display area 10a on the second substrate 20 is mirror-symmetrical with that on the first substrate 10. On the second substrate 20, second data lines 114b and second scanning lines 112b are disposed in association with the first data lines 114a and the first scanning lines 112a, respectively, on the first substrate 10. The second scanning lines 112b are disposed while intersecting with the second data lines 114b, and the pixel portions 70 are disposed at the intersections of the corresponding second scanning lines 112b and second data lines 114b.

The configuration of the second scanning line drive circuits 104b is similar to that of the first scanning line drive circuits 104a. As in the first scanning line drive circuit 104a, the second scanning line drive circuit 104b is driven based on a Y clock signal CLY, an inverted Y clock signal CLYinv, and a Y start pulse DY, and sequentially generates and outputs second scanning signals Gb1, Gb2, . . . , and Gbm.

The second scanning lines 112b on the second substrate 20 are selected based on the second scanning signals Gbj (j=1, 2, . . . , and m) output from the second scanning line drive circuit 104b in accordance with the selection order based on the first scanning signals Gaj and in synchronization with the output timing of the first scanning signals Gaj to the first scanning lines 112a.

The configuration of the second data line drive circuit 101b is similar to that of the first data line drive circuit 101a. As in the first data line drive circuit 101a, the second data line drive circuit 101b is driven based on an X clock signal CLX, an inverted X clock signal CLXinv, and an X start pulse DX, and sequentially generates and outputs second sampling signals Sb1, Sb2, . . . , Sbn−2, Sbn−1, and Sbn. Additionally, as in the first sampling circuit 200a, the second sampling circuit 200b includes second sampling switches 202b in association with the second data lines 114b.

On the second substrate 20, the defective information storage unit 500 formed of a fuse pattern or a non-volatile storage unit, such as a semiconductor memory, is provided within the drive controller 500c that is disposed on the second substrate 20 as one of the peripheral circuit. The first image signal V1 and the second image signal V2 generated by the image signal processing circuit 300 are supplied to the drive controller 500c. In the defective information storage unit 500, at least one defective cell data, which serves as defective pixel data (described below), concerning a cell that has become defective due to a break in a fuse, is stored. The second sampling signals Sbi output from the second data line drive circuit 101b and the second scanning signals Gbj output from the second scanning line drive circuit 104b are input into the drive controller 500c, and when supplying image data to a defective cell, i.e., a defective pixel portion, the first image signal V1 or the second image signal V2 is output from the drive controller 500c on the basis of the defective cell data stored in the defective information storage unit 500.

The first image signal V1 or the second image signal V2 output as described above is supplied to the image signal line 171b. In this embodiment, in normal driving, the second data lines 114b are driven based on the second image signal V2. However, when driving a defective pixel portion among the pixel portions 70 in the image display area 10a, the first image signal V1 is output to the corresponding second data line 114b from the image signal line 171b via the second sampling circuit 200b. Details of this operation are discussed below. If the first image signal V1 or the second image signal V2 is expanded into 6, 12, . . . parallel signals, a plurality of image signal lines 171b corresponding to the number of expanded image signals V1 or V2 are formed, as in the image signal lines 171a on the first substrate 10. In this case, the 6, 12, . . . image signals V1 or V2 supplied to the image signal lines 171b may be supplied to the 6, 12, . . . second data lines 114a by groups as in the first substrate 10. As in FIG. 45 only one image signal line 171b is shown in FIG. 5.

The second sampling signals Sbi are sequentially supplied to the second sampling switches 202b of the second sampling circuit 200b in accordance with the output order of the first sampling signals Sai from the first data line drive circuit 101a and in synchronization with the output timing thereof. Accordingly, the first image signal V1 or the second image signal V2 is output to each second data line 114b in accordance with the output order of the first image signals V1 to the first data lines 114a and in synchronization with the output timing thereof.

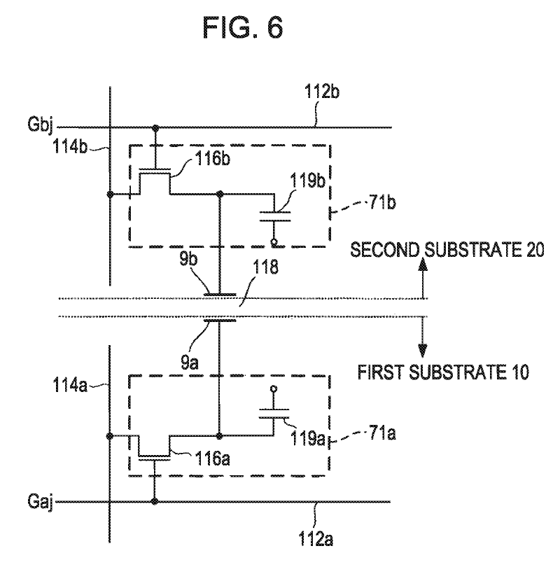

The electrical configuration of a certain pixel portion 70 is described below with reference to FIG. 6.

As stated above, the pixel portions 70 are formed at the intersections of the corresponding first data lines 114a and first scanning lines 112a on the first substrate 10, and are also formed at the intersections of the corresponding second data lines 114b and second scanning lines 112b on the second substrate 20. In each pixel portion 70, in addition to the first electrode 9a, a first pixel circuit 71a for driving the first electrode 9a is formed on the first substrate 10. The first pixel circuit 71a includes a first TFT 116a, which serves as a first active element, for controlling the switching of the first electrode 9a. The first data line 114a is electrically connected to the source electrode of the first TFT 116a, the first scanning line 112a is electrically connected to the gate electrode of the first TFT 116a, and the first electrode 9a is connected to the drain electrode of the first TFT 116a. The first TFT 116a (first active element) may be formed of another type of transistor different from a TFT, or a diode, such as a thin-film diode (TFD).

In the first pixel circuit 71a, to prevent a considerable change in the potential of the first electrode 9a by an OFF-state leakage current, a first storage capacitor 119a is added in parallel with the first electrode 9a, i.e., a liquid crystal capacitor. Because of the provision of the first storage capacitor 119a, the potential of the first electrode 9a is held in the first storage capacitor 119a over a period longer than the period for which the first image signal V1 is applied through the first TFT 116a by three orders of magnitude. As a result of the enhanced potential retaining characteristic, the higher contrast ratio can be implemented. The first storage capacitor 119a includes a fixed potential capacitor electrode, and is also electrically connected to a capacitor electrode 113a fixed at a constant potential.

The configuration of the pixel portion 70 on the second substrate 20 is mirror-symmetrical with that of the first substrate 10 when viewed from the surface of the first substrate 10 that faces the second substrate 20. On the second substrate 20, not only the second electrode 9b, but also a second pixel circuit 71b, is formed on each pixel portion 70. The second pixel circuit 71b is configured similarly to the first pixel circuit 71a, and includes a second TFT 116b, which is an example of a second active element, for controlling the switching of the second electrode 9b, and a second storage capacitor 119b. As in the first storage capacitor 119a, the second storage capacitor 119b includes a fixed potential capacitor electrode, and is also electrically connected to a capacitor electrode 113b shown in FIG. 5. Accordingly, in this embodiment, in each pixel portion 70, a liquid crystal is held between the first electrode 9a and the second electrode 9b to form a liquid crystal holding capacitor 118.

In each pixel portion 70, the first electrode 9a and the second electrode 9b are disposed in the aperture area, while the first TFT 116a, the second TFT 116b, the first storage capacitor 119a, and the second storage capacitor 119b are disposed in the non-aperture area.

When driving the liquid crystal device, in each pixel portion 70 on the first substrate 10, a first scanning signal Gaj is supplied to the first TFT 110a of the first pixel circuit 71a via the first scanning line 112a to turn ON the first TFT 116a, and a first image signal V1 is supplied to the first electrode 9a from the first data line 114a via the first TFT 116a. Meanwhile, in each pixel portion 70 on the second substrate 20, as in the first pixel circuit 71a, the second pixel circuit 71b is driven based on the second scanning signal Gbj and the second image signal V2 in synchronization with the driving of the first pixel circuit 71a, and the second image signal V2 is supplied to the second electrode 9b.

In each pixel portion 70, due to the potential difference between the first electrode 9a and the second electrode 9b, vertical electric fields corresponding to the image data to be displayed in each pixel are preferentially generated in the liquid crystal, and a voltage defined by the potential difference is applied to the liquid crystals The orientation and order of the molecular assembly of the liquid crystal are changed in accordance with the level of the applied voltage, and then, the liquid crystal modulates light and implements the grayscale display. In the normally white mode, the transmission factor of the liquid crystal in response to incident light is decreased as the voltage applied to each pixel increases. In the normally black mode, the transmission factor of the liquid crystal in response to incident light is increased as the voltage applied to each pixel increases. When considering the transmission factors of all the pixels of the image display area, light having a contrast level in accordance with the first image signal V1 and the second image signal V2 is emitted from the liquid crystal panel 100.

According to the liquid crystal device of this embodiment, in each pixel portion 70, the first electrodes 9a can be driven independently, and the second electrodes 9b can be driven independently. In the liquid crystal panel 100, in each pixel portion 70, the second pixel circuit 71b is disposed on a substrate different from the substrate on which the first electrode 9a and the first pixel circuit 71a are disposed so that an increase in the sizes of the first substrate 10 and the second substrate 20 can be suppressed. Additionally, the miniaturization of each pixel portion 70 can be enhanced, and the aperture ratio can also be increased.

Operation of Electro-optical Device

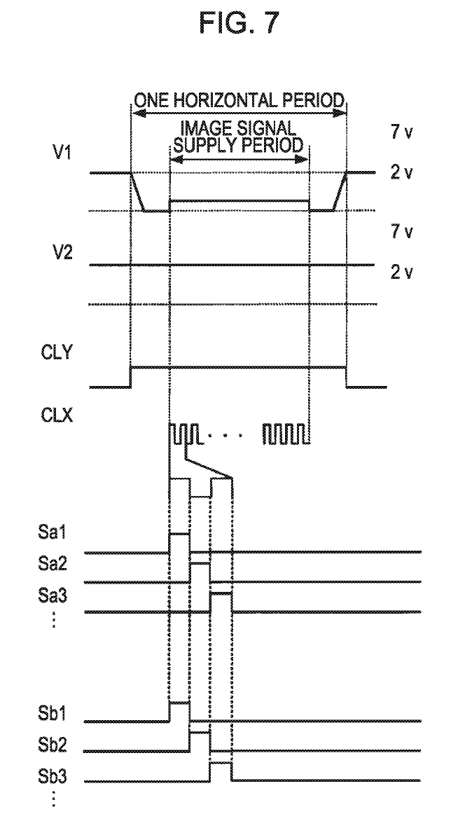

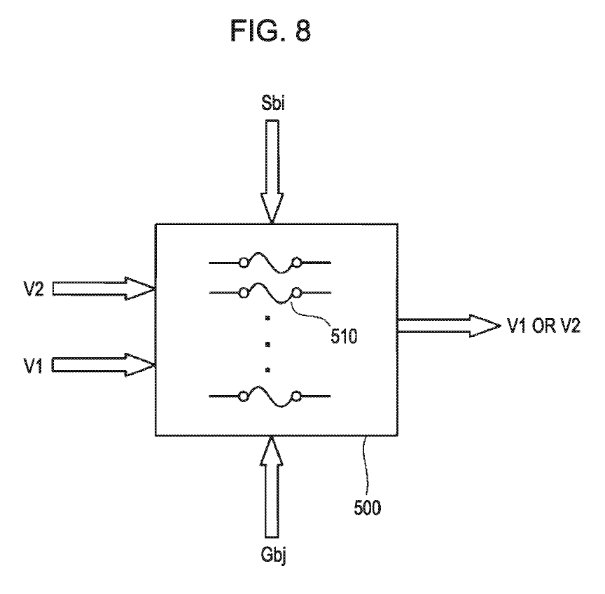

The operation of the liquid crystal device, which is an example of the electro-optical device, of this embodiment is described below with reference to FIGS. 7 and 8, in addition to FIGS. 1 through 6.

FIG. 7 is a timing chart illustrating temporal changes in various signals for operating the liquid crystal device. FIG. 8 schematically illustrates the configuration and operation of the defective information storage unit 500.

The plurality of first scanning lines 112a are disposed horizontally in the X direction (row direction) while intersecting with the first data lines 114a extending in the Y direction (column direction). In this embodiment, it is now assumed that the first scanning lines 112a are selected in the order, for example, from the bottom to the top in FIG. 4. The second scanning lines 112b are disposed horizontally in the X direction (row direction) while intersecting with the second data lines 114b extending in the Y direction (column direction), and are selected in the order, for example, from the bottom to the top in FIG. 5. A description is given below by focusing on the pixel portions 70 corresponding to the j-th first scanning line 112a and the j-th second scanning line 112b.

It is now assumed that the normally white mode is employed in the liquid crystal in each pixel portion 70 In FIG. 7, in each pixel portion 70, to display a black color by the liquid crystal, the potential difference between the first electrode 9a and the second electrode 9b driven by the first image signal V1 and the second image signal V2, respectively, is 5 V. To display images, the potential of each of the first image signal V1 and the second image signal V2 is changed between 7 V and 2 V.

In FIG. 7, at the start of one horizontal period, the Y clock signal CLY rises from the low level to the high level, and then, on the first substrate 10, the first scanning signal Gaj is supplied to the j-th first scanning line 112a from the first scanning line drive circuit 104a. The Y clock signal CLY is maintained at the high level throughout one horizontal period, and the j-th first scanning line 112a is selected in this horizontal period. On the second substrate 20, the second scanning signal Gbj is supplied to the j-th second scanning line 112b from the second scanning line drive circuit 104b in synchronization with the output timing of the first scanning signal Gaj to the j-th first scanning line 112a, and then, the j-th second scanning line 112b is selected in this horizontal period. As a result, the pixel portions 70 corresponding to the j-th first and second scanning lines 112a and 112b can be selected.

Then, during an image signal supply period, the first image signal V1 and the second image signal V2 whose potentials are adjusted to predetermined values are supplied from the image signal processing circuit 300. More specifically, in the image signal supply period, in FIG. 7, the first image signal V1 is adjusted to a value between 7 V and 2 V so that the potential can be adjusted independently for each first data line 114a, and is then supplied. The potential of the second image signal V2 is fixed to 7 V.

During the image signal supply period, on the first substrate 10, in synchronization with the rising of the X clock signal CLX from the low level to the high level or the falling of the X clock signal CLX from the high level to the low level, the first sampling signals Sa1, Sa2, . . . , San−2, San−1, and San are sequentially output from the first data line drive circuit 101a to the first data lines 114a in the order of, for example, from the left to the right in FIG. 4. Accordingly, in the first sampling circuit 200a, the first sampling switches 202a are sequentially turned ON in response to the first sampling signals Sai. Then, the first image signal V1 is sequentially supplied to the first data lines 114a via the first sampling switches 202a in accordance with the output order of the first sampling signals Sa1, Sa2, . . . , San−2, San−1, and San.

Meanwhile, during the image signal supply period, on the second substrate 20, the second sampling signals Sb1, Sb2, . . . , Sbn−2, Sbn−1, and Sbn are sequentially output from the second data line drive circuit 101b in accordance with the output order of the first sampling signals Sa1, Sa2, . . . , San−2, San−1, and San and in synchronization with the output timing of each first sampling signal. In this case, the second sampling signals are output in the order of, for example, from the right to the left in FIG. 5. In FIG. 5, the configuration of the second substrate 20 is shown when viewed from the surface of the first substrate 10 that faces the second substrate 20. Accordingly, the output order of the first sampling signals Sa1, Sa2, . . . , San−2, San−1, and San in FIG. 4 and the output order of the second sampling signals Sb1, Sb2, . . . , Sbn−2, Sbn−1, and Sbn in FIG. 5 are opposite to each other.

Then, in the second sampling circuit 200b, the second sampling switches 202b are sequentially turned ON in the X direction in response to the second sampling signals Sbi. Then, the second image signal V2 is sequentially supplied to the second data lines 114b via the second sampling switches 202b in accordance with the output order of the second sampling signals Sb1, Sb2, . . . , Sbn−2, Sbn−1, and Sbn and in synchronization with the output timing of the first image signal V1 to the first data lines 114a.

As a result, in the pixel portions 70 corresponding to the j-th first scanning line 112a and the j-th second scanning line 112b, the first image signal V1, is supplied to the first electrodes 9a, while the second image signal V2 is supplied to the second electrodes 9b in synchronization with the supply timing of the first image signal V1 to the first electrodes 9a.

When manufacturing the liquid crystal device, in each pixel portion 70, a fault may occur in the first pixel circuit 71a due to a short circuit or a break in the electrical path from the first data line 114a to the first electrode 9a. A pixel in which a fault has occurred in the first pixel circuit 71a has become defective, and the potential of the first electrode 9a of such a pixel is fixed at, for example, 7 V.

In this embodiment, as discussed with reference to FIG. 5, the drive controller 500c including the defective information storage unit 500 is provided on the second substrate 20 as a peripheral circuit. In FIG. 8, in the defective information storage unit 500, fuses 510 are arranged on the second substrate 20, and the positions of the individual pixel portions 70 formed in the image display area 10a on the second substrate 20 are represented by the arrangement of the fuses 510. Accordingly, the configuration of the defective information storage unit 500 can be simplified.

Ten, the liquid crystal device is driven as a test in various inspections while the liquid crystal device is being manufactured or before it is shipped after being manufactured. In this case, if a defective pixel portion (i.e., a defective cell), such as that described above, is detected, the fuse 510 representing the position of the defective pixel portion is cut off with a laser so that defective cell data indicating the address information concerning the position of the defective pixel portion in the image display area 10a is stored in the defective information storage unit 500. With this configuration, at least one defective cell data indicating the address information concerning the corresponding defective pixel portion is stored in, the defective information storage unit 500.

When driving the liquid crystal device, if the second sampling signals Sbi and the second scanning signals Gbj are input into the drive controller 500c, instead of the second image signal V2, the first image signal V1 supplied to the defective pixel portion on the first substrate 10 is also supplied to the image signal line 171b on the second substrate 20 on the basis of the defective cell data stored in the defective information storage unit 500. Accordingly, in response to the second sampling signal Sbi which is also supplied to the drive controller 500c, the first image signal V1 is supplied to the second data line 114b corresponding to the defective pixel portion via the second sampling switch 202b of the second sampling circuit 200b while the second scanning line 112b corresponding to the defective pixel portion is being selected by the second scanning signal Gbj which is also supplied to the drive controller 500c. The first image signal V1 is then supplied to the second pixel circuit 71b of the defective pixel portion from the second data line 114b. In the defective pixel portion, the potential of the first electrode 9a is fixed at 7 V, while the potential of the second electrode 9b is adjusted to a value between 7 V and 2 V on the basis of the first image signal V1. Thus, an image can be displayed correctly even in the defective pixel portion.

In this embodiment, therefore, in each pixel portion 70, the first pixel circuit 71a of a pixel portion which has become defective can be replaced with the second pixel circuit 71b. That is, the second pixel circuit 71b can serve as a redundancy circuit.

As stated above, the defective information storage unit 500 may be a fuse pattern for storing defective cell data. Alternatively, it may be a non-volatile semiconductor memory. In this case, the drive controller 500c refers to the cell data stored in the defective information storage unit 500 beforehand so that the output of the image signals can be adjusted and modified.

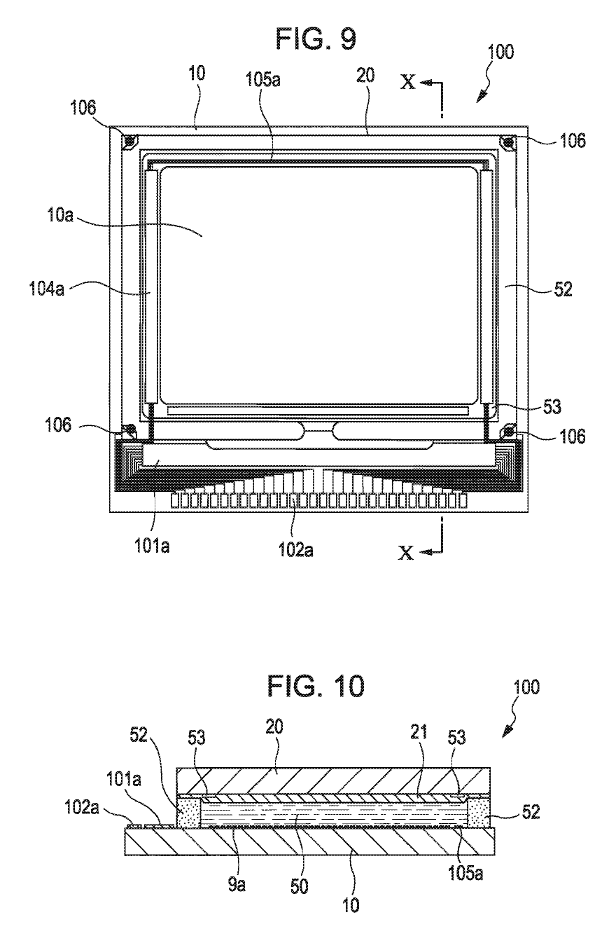

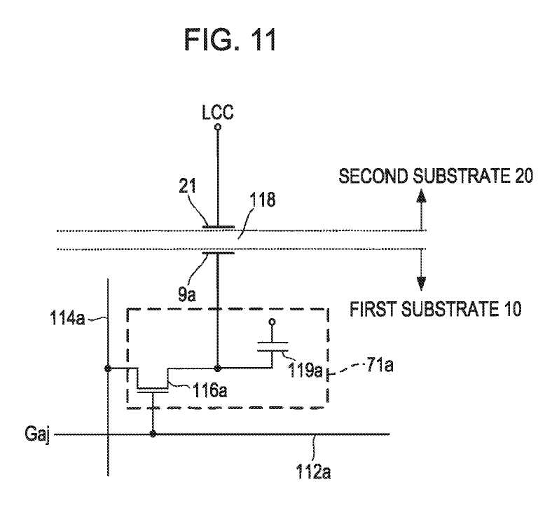

A liquid crystal device, which serves as a comparative example for the liquid crystal device of this embodiment, is shown in FIGS. 9 through 11. Only features and configurations different from those of the first embodiment are discussed below. FIG. 9 is a plan view illustrating the schematic configuration of a liquid crystal panel of the comparative example. FIG. 10 is a sectional view taken along line X-X in FIG. 9. FIG. 11 illustrates the electrical configuration of a certain pixel portion of the comparative example.

In the comparative example, in the liquid crystal panel 100, the configuration of the second substrate 20 is different from that of the first embodiment. More specifically, peripheral circuits, such as the second data line drive circuit 101b and the second scanning line drive circuits 104b, are not provided on the second substrate 20, and in the image display area 10a, neither of the second data lines 114b nor the second scanning lines 112b are formed, and also, the second pixel circuit 71b formed in each pixel portion 70 in the first embodiment is not formed.

As shown in FIG. 10, a counter electrode 21, which is equivalent to the second electrodes 9b of the first embodiment, is formed on substantially the entire image display area 10a on the surface of the second substrate 20 that faces the first substrate 10. The counter electrode 21 opposes the plurality of first electrodes 9a formed on the first substrate 10 across the liquid crystal layer 50. Then, on the second substrate 20, an alignment film is formed on a layer higher than the counter electrode 21 (i.e., lower than the counter electrode 21 in FIG. 10). In FIG. 9, upper and lower conductor terminals 106 are disposed at the four corners of the image display area 10a on the first substrate 10, and an electrical connection between the first substrate 10 and the second substrate 20 can be established by the upper and lower conductor terminals 106 so that the counter electrode 21 can be driven.

In the liquid crystal device of this comparative example, unlike the liquid crystal device of the first embodiment show in FIG. 3, only the first image signal V1 is generated and output from the image signal processing circuit 300, and a power supply Circuit that supplies a common electrode potential LCC for driving the counter electrode 21 to the liquid crystal panel 100 is also provided. Thus, according to the comparative example, when driving the liquid crystal device, the counter electrode 21 is maintained at a predetermined potential which is common for all the pixel portions 70 on the basis of only the common electrode potential LCC supplied form the power supply circuit via the upper and lower conductor terminals 106 .

With this configuration, in each pixel portion 70, as show in FIG. 11, a liquid crystal holding capacitor 118 is formed between the first electrode 9a formed on the first substrate 10 and the counter electrode 21 which is formed for all the pixel portions 70 and which is maintained at the common potential.

According to the liquid crystal device of the comparative example, in each pixel portion 70, if a fault occurs in the first pixel circuit 71a, an image cannot be displayed correctly, which causes a point defect and further reduces the manufacturing yield. Additionally, unlike the liquid crystal device of the first embodiment, it is impossible that the counter electrode 21 is driven individually for each pixel portion 70 on the second substrate 20.

In contrast, according to the first embodiment, as stated above, since the second pixel circuit 71b of each pixel portion 70 can serve as a redundancy circuit, the problem of the reduced manufacturing yield can be solved. In addition to the first electrodes 9a on the first substrate 10, the second electrodes 9b on the second substrate 20 can also be driven independently for the individual pixel portions 70. Accordingly, the voltage applied to the electro-optical material, such as a liquid crystal, based on the potential difference between the first electrode 9a and the second electrode 9b can be controlled for each pixel portion 70. As a result, the flexibility to drive each pixel portion 70 in this embodiment can be increased compared with the configuration of the liquid crystal device of the comparative example.

In the above-described first embodiment, in the liquid crystal panel 100, the second electrodes 9b may be formed for the individual pixel portions 70, together with the first electrodes 9a, in the image display area 10a on the first substrate 10. Alternatively, the first electrodes 9a and the second electrodes 9b may be formed on the first substrate 10 and the second substrate 20, respectively, as discussed with reference to FIGS. 1 through 6, only for some pixel portions 70, and for the remaining pixel portions 70, the first electrodes 9a and the second electrodes 9b may be formed on one of the first substrate 10 and the second substrate 20. Additionally, in each pixel portion 70, the second pixel circuit 71b may be formed on a substrate different from the substrate 10 or 20 on which the second electrode 9b is formed, in which case, in each pixel portion 70, the first pixel circuit 71a and the second pixel circuit 71b may be formed on the same substrate.

Between the first substrate 10 and the second substrate 20, if the first electrodes 9a and the second electrodes 9b are formed on the same substrate, horizontal electric fields are preferentially generated due to the potential difference between the first electrodes 9a and the second electrodes 9b, and the voltage defined by the potential difference is applied to the liquid crystal.

Modified Examples

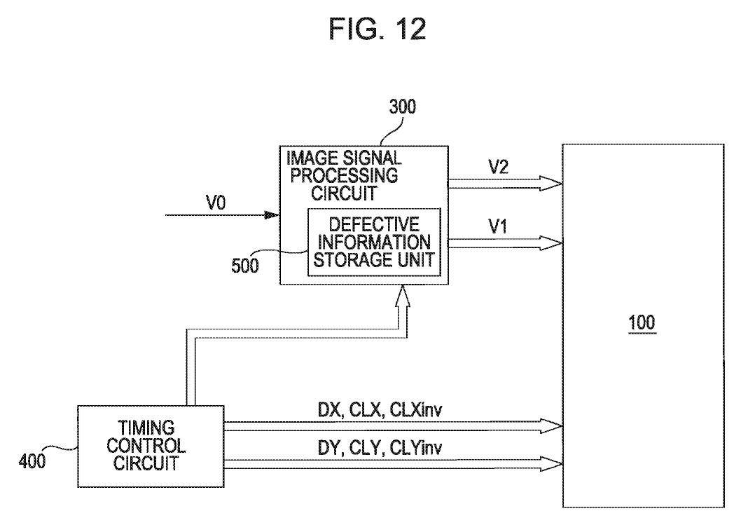

An example modified to the first embodiment is described below with reference to FIG. 12. FIG. 12 is a block diagram illustrating the overall configuration of a liquid crystal device of this modified example.

In FIG. 12, the defective information storage unit 500 is disposed within the image signal processing circuit 300 rather than on the liquid crystal panel 100. The image signal processing circuit 300 generates the first image signal V1 and the second image signal V2 based on the defective cell data stored in the defective information storage unit 500. The defective information storage unit 500 is formed of, for example, a non-volatile semiconductor memory, and the image signal processing circuit 300 can refer to the defective cell data stored in the defective information storage unit 500 if necessary.

Moore specifically, based on the defective cell data stored in the defective information storage unit 500, the image signal processing circuit 300 supplies the first image signal V1 instead of the second image signal V2 to the image signal supply line 171b on the second substrate 20 in synchronization with the output timing of the second sampling signal Sbi from the second data line drive circuit 101b, the second sampling signal Sbi being used for supplying the image signal to the defective pixel portion. Then, on the second substrate 20, in response to the second sampling signal Sbi, the first image signal V1 is supplied to the second data line 114b corresponding to the defective pixel portion via the second sampling switch 202b of the second sampling circuit 200b while the second scanning line 112b corresponding to the defective pixel portion is being selected by the second scanning signal Gbj.

Alternatively, based on the defective cell data stored in the defective information storage unit 500, the image signal processing circuit 300 may adjust the potential of the second image signal V2 on the basis of the first image signal V1, and supplies the adjusted second image signal V2 to the image signal supply line 171b on the second substrate 20 in synchronization with the output timing of the second sampling signal Sbi from the second data line drive circuit 101b, the second sampling signal Sbi being used for supplying the image signal to the defective pixel portion. In this case, the second image signal V2 having the adjusted potential is supplied to the second data line 114b corresponding to the defective pixel portion from the image signal supply line 171b via the second sampling circuit 200b, and is then supplied to the second electrode 9b from the second data line 114b via the second pixel circuit 71b of the defective pixel portion. As a result, the potential difference between the first electrode 9a and the second electrode 9b can be adjusted to a predetermined value.

Thus, as in the first embodiment, in this modified example, the second pixel circuit 71b in each pixel portion 70 can serve as a redundancy circuit.

Second Embodiment

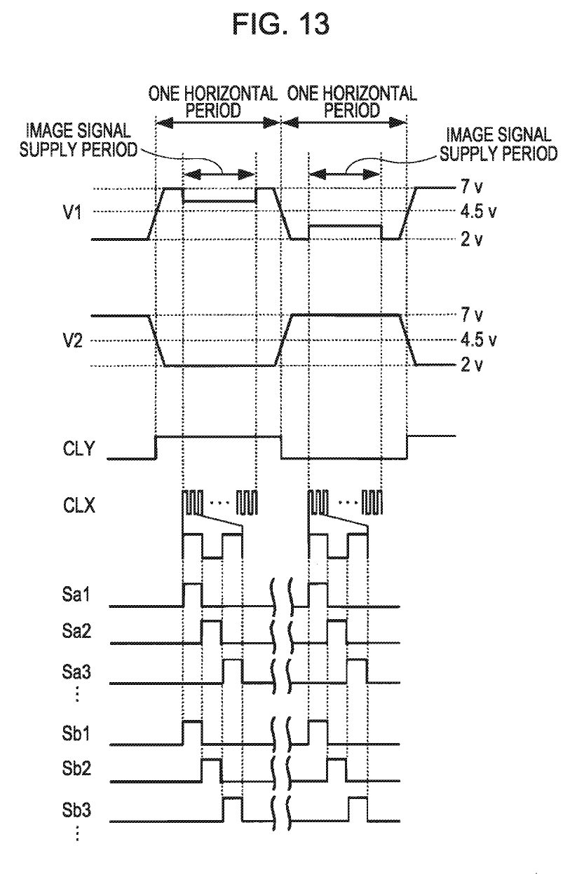

An electro-optical device according to a second embodiment of the invention is described below with reference to FIGS. 13 through 17. In the following description, the configuration and operation similar to those of the first embodiment are not given or are sometimes explained with reference to FIGS. 1 through 8, and the configuration and operation different from those of the first embodiment are discussed below.

In the second embodiment, in a liquid crystal device, which is an example of the electro-optical device, the image signal processing circuit 300 inverts the potential of the first image signal V1 and the potential of the second image signal V2 to the higher positive polarity (+) and the lower negative polarity (−) with respect to a predetermined reference potential, and outputs the first image signal V1 and second image signal V2 with the converted polarities. In the second embodiment, a defective information storage unit, such as that described in the first embodiment, is not provided, and in each pixel portion 70 on the second substrate 20, the second pixel circuit 71b does not serve as a redundancy circuit. Accordingly, on the second substrate 20, only the second image signal V2 is supplied to the image signal line 171b from the image signal processing circuit 300.

FIG. 13 is a timing chart illustrating temporal changes in various signals for operating the liquid crystal device in the second embodiment. A description is given below by focusing on the pixel portions 70 corresponding to the (j−1)-th and j-th first scanning lines 112a and second scanning lines 112b. As in the first embodiment, the normally white mode is employed in the liquid crystal.

FIG. 13, at the start of one horizontal period during which the (j−1)-th first scanning line 112a and the (j−1)-th second scanning line 112b are being selected, the Y clock signal CLY rises from the low level to the high level. Then, the first scanning signal Gaj−1 is output to the (j−1)-th first scanning line 112a from the first scanning drive circuit 104a. In synchronization with the output timing of the first scanning signal Gaj−1, the second scanning signal Gbj−1 is supplied to the (j−1)-th second scanning line 112b from the second scanning line drive circuit 104b.

In the image signal processing circuit 300, at the start of this horizontal period, the potential of the first image signal V1 is inverted to the higher positive polarity (+) with respect to the reference potential, i.e., 4.5 V, and the potential of the second image signal V2 Is inverted to the lower negative polarity (−) with respect to the reference potential, i.e., 4.5 V. Then, during the horizontal period during which the (j−1)-th first scanning line 112a and the (j−1)-th second scanning line 112b are being selected, the potential of the second image signal V2 is fixed at 2 V. During the image signal supply period, the potential of the first image signal V1 is adjusted with respect to the potential of the second image signal V2 to a value between 7 V and 2 V so that the potential can be adjusted individually for each first data line 114a.

The state in which the (j−1)-th first scanning line 112a and the (j−1)-th second scanning line 112b are being selected, in the image signal supply period, in synchronization with the rising of the X clock signal CLX from the low level to the high level or the falling of the X clock signal CLX from the high level to the low level, on the first substrate 10, the first sampling signals Sa1, Sa2, . . . , San−2, San−1, and San are sequentially output to the first sampling circuit 200a from the first data line drive circuit 101a. Then, the first image signal V1 is supplied to the first data lines 114a via the first sampling switches 202a in accordance with the output order of the first sampling signals Sa1, Sa2, . . . , San−2, Sa−1, and San. Meanwhile, on the second substrate 20, the second sampling signals Sb1, Sb2, . . . , Sbn−2, Sbn−1, and Sbn are sequentially output to the second sampling circuit 200b from the second data line drive circuit 101b in accordance with the output order of the first sampling signals Sa1, Sa2, . . . , San−2, San−1, and San and in synchronization with the output timing of each of the first sampling signals. Then, the second image signal V2 is sequentially supplied to the second data lines 114b via the second sampling switches 202b in accordance with the output order of the second sampling signals Sb1, Sb2, . . . , Sbn−2, Sbn−1, and Sbn and in synchronization with the output timing of the first image signal V1 to the first data lines 114a.

As a result, in the pixel portions 70 corresponding to the (j−1)-th first scanning line 12a and the (j−1)-th second scanning line 12b, the first image signal V1 having the positive polarity is supplied to the first electrodes 9a, and the second image signal V2 having the negative polarity is supplied to the second electrodes 9b in synchronization with the supply timing of the first image signal V1 to the first electrodes 9a. After the lapse of the image signal supply period, the horizontal period is completed.

Then, at the start of the subsequent horizontal period, the Y clock signal CLY falls from the high level to the low level, and the j-th first scanning line 112a is selected based on the first scanning signal Gaj supplied from the first scanning line drive circuit 104a, while the j-th second scanning line 112b is selected based on the second scanning signal Gbj supplied from the second scanning line drive circuit 104b.

At the start of this horizontal period, the image signal processing circuit 300 inverts the potential of the first image signal V1 from the positive polarity to the negative polarity with respect to the reference potential, and also inverts the potential of the second image signal V2 from the negative polarity to the positive polarity with respect to the reference potential. In the horizontal period during which the j-th first scanning line 112a and the j-th second scanning line 112b are being selected, the potential of the second image signal V2 is fixed at 7 V. During the image signal supply period, the potential of the first image signal V1 is adjusted with respect to the potential of the second image signal V2 to a value between 7 V and 2 V so that the potential of each first data line 114a can be adjusted.

In the state in which the j-th first scanning line 112a and the j-th second scanning line 112b are being selected, in the image signal supply period, in synchronization with the rising of the X clock signal CLX from the low level to the high level or the falling of the X clock signal CLX from the high level to the low level, on the first substrate 10, the first sampling signals Sa1, Sa2, San−2, San−1, and San are sequentially output from the first data line drive circuit 101a, and also, the second sampling signals Sb1, Sb2, . . . , Sbn−2, Sbn−1, and Sbn are sequentially output from the second data line drive circuit

Then, the first image signal V1 is supplied to the first data lines 114a via the first sampling switches 202a in accordance with the output order of the first sampling signals Sa1, Sa2, . . . , San−2, San−1, and San. Meanwhile, the second image signal V2 is sequentially supplied to the second data lines 114b via the second sampling switches 202b in accordance with the output order of the second sampling signals Sb1, Sb2 . . . , Sbn−2, Sbn−1, and Sbn and in synchronization with the output timing of the first image signal V1 to the first data lines 114a.

In the pixel portions 70 corresponding to the j-th first scanning line 12a and the both second scanning line 12b, the first image signal V1 having the negative polarity is supplied to the first electrodes 9a, and the second image signal V2 having the positive polarity is supplied to the second electrodes 9b in synchronization with the supply timing of the first image signal V1 to the first electrodes 9a.

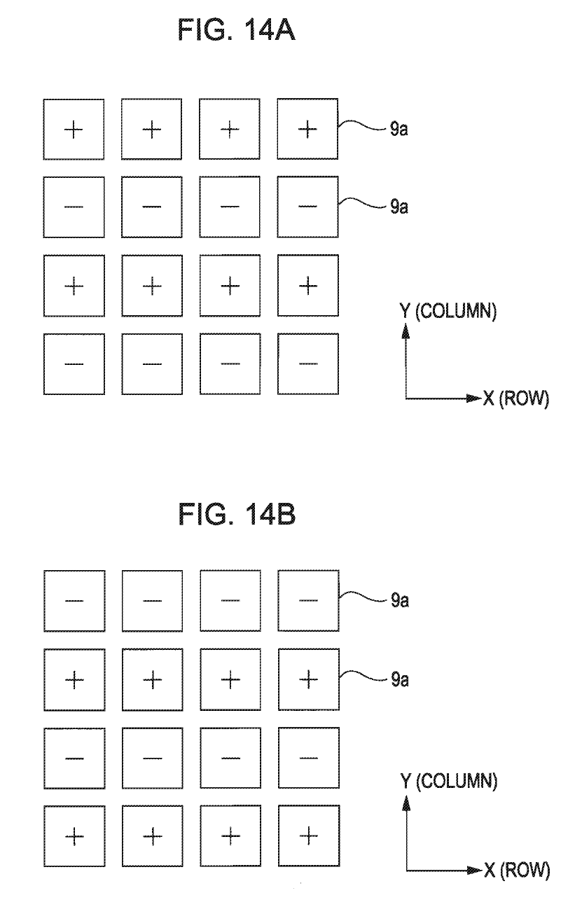

In this case, therefore, driving similar to the common-electrode-potential switching driving can be performed, and also, line inversion driving, which is described below, can be performed in the liquid crystal device. FIGS. 14A and 14B are schematic diagrams illustrating the line inversion driving.

The FIG. 14A, if the pixel portions 70 are driven according to the operation discussed with reference to FIG. 13, in a certain vertical period, the potentials of the first electrodes 9a that are aligned in the same first scanning line 112a have the same polarity, and the potentials of the first electrodes 9a in the adjacent first scanning line 112a have the polarity opposite to the polarity of the first electrodes 9a in the previous first scanning line 112a. The same applies to the second electrodes 9b, and when driving the pixel portions 70, the potentials of the second electrodes 9b that are aligned in the same second scanning line 112b have the same polarity, and the potentials of the second electrodes 9b in the adjacent second scanning line 112b have the polarity opposite to the polarity for the second electrodes 9b in the previous second scanning line 112b.

Then, in the subsequent vertical period, which is temporally continuous from the previous vertical period, in the pixel portions 70, as shown in FIG. 141, the polarity of the potential of the first electrodes 9a is inverted line by line with respect to the reference potential. Also, the polarity of the potential of the second electrodes 9b is inverted line by line with respect to the reference potential in synchronization with the first electrodes 9a. After the polarity inversion, the polarity of the potential of the first electrodes 9a in one row is opposite to the polarity of the potential of the first electrodes 9a in the adjacent row. The same applies to the second electrodes 9b.

According to the configuration of the comparative example discussed with reference to FIGS. 9 through 11, when performing line inversion driving in a manner similar to the operation discussed with reference to FIG. 13, in every scanning period, the common electrode potential LCC is inverted to the polarity with respect to the reference potential, and is then supplied to the counter electrode 12, which is equivalent to the second electrodes 9b. Thus, in the pixel portions 70 other than the pixel portions 70 having the first electrodes 9a to which the first image signal V1 is supplied, the potentials of the first electrodes 9a may deviate from the potential of the first image signal V1 due to push-up or push-down caused by fluctuations in the potential of the counter electrode 21.

For example, in the pixel portions 70 belonging to adjacent rows, during a certain horizontal period, the common electrode potential LCC is driven at 7 V, which is the positive polarity, and the first image signal V1 having the negative polarity is supplied to the first electrodes 9a of the pixel portions 70 belonging to one of the adjacent rows (first adjacent row). Then, in the subsequent Horizontal period, the common electrode potential LCC is driven at 2 V, which is the negative polarity, and the first image signal V1 having the positive polarity is supplied to the first electrodes 9a of the pixel portions 70 belonging to the other adjacent row (second adjacent row). In this case, in the pixel portions 70 belonging to the first adjacent row to which the first image signal V1 has been supplied, the potential of the first electrodes 9a is pushed down to be lower than the first image signal V1 due to fluctuations in the potential of the counter electrode 21.

If any countermeasure against this problem is not taken, in each pixel portion 70, the potential difference between the source and the drain of the first TFT 116a is increased due to the fluctuations in the potential of the counter electrode 21. Also, a large amount of current is required for inverting the polarity of the counter electrode 21, and thus, it is difficult to stably drive the pixel portions 70.

Additionally, in each pixel portion 70, the level of light leakage in the first TFT 110a becomes different between when the first electrode 9a is driven with the positive polarity and when the potential of the first electrode 9a is driven with the negative polarity. Accordingly, in each pixel portion 70, the potential difference between the first electrode 9a and the second electrode 9b is changed due to light leakage, and accordingly, the voltage applied to the liquid crystal is also changed. This encourages the occurrence of flickering, and the image quality is deteriorated.

According to the second embodiment, however, in each pixel portion 70, the current for driving each of the first electrode 9a and the second electrode 9b is smaller than that required for driving the counter electrode 21 in the comparative example. Accordingly, the potentials of the first electrode 9a and the second electrode 9b can be easily stabilized, and the pixel portion 70 can be driven at high speed.

The potential difference between the first electrode 9a and the second electrode 9b can be individually controlled for each pixel portion 70. Accordingly, in each pixel portion 70, the polarity inversion of the first electrode 9a can be synchronized with that of the associated second electrode 9b. Thus, in each pixel portion 70, the potential of one of the first electrode 9a and the second electrode 9b is not pushed up or pushed down since the potential of the other electrode is not fluctuated. Thus, compared with the comparative example, in each pixel portion 70, the source-drain breakdown voltage can be decreased both in the first TFT 116a of the first pixel circuit 71a and the second TFT 116b of the second pixel circuit 71b. Accordingly, in each pixel portion 70, the area where both the first TFT 116a and the second TFT 116b are formed can be made smaller, and the miniaturization of the pixel portions 70 can be enhanced and the aperture ratio is also increased. As a result, in the liquid crystal device, the luminance can be enhanced by utilizing light more efficiently, and also, high-definition image display can be implemented.

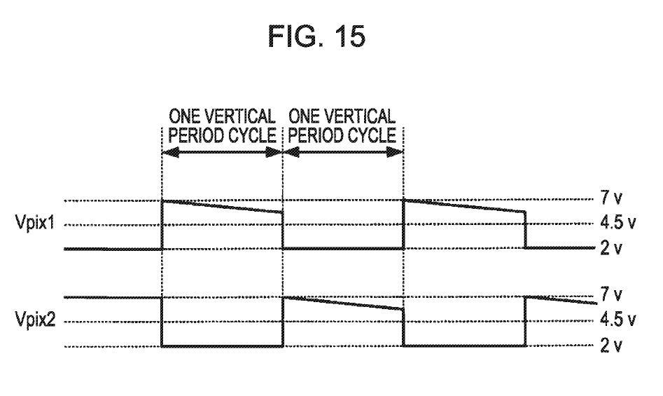

FIG. 15 is a diagram illustrating temporal changes in the potential of the first electrode 9a and the potential of the second electrode 9b during one vertical period cycle. In FIG. 15, temporal changes in the potential Vpix1 of the first electrode 9a and in the potential Vpix2 of the second electrode 9b during one vertical period cycle when a black color is displayed are shown.

In the second embodiment, in each pixel portion 70, the level of light leakage of the first TFT 116a when the first electrode 9a is driven with the positive polarity can be equivalent to the level of light leakage of the second TFT 116b when the second electrode 9b is driven with the negative polarity.

More specifically, in FIG. 15, during a period equivalent to one vertical period, in a certain pixel portion 70, for example, the first electrode 9a is driven while the potential Vpix1 is maintained at the positive polarity, and the second electrode 9b is driven while the potential Vpix2 is maintained at the negative polarity. In this case, light leakage occurring in the first TFT 116a of the first pixel circuit 71a for driving the first electrode 9a is larger than light leakage occurring in the second TFT 116b of the second pixel circuit 71b for driving the second electrode 9b. Thus, the potential Vpix1 of the first electrode 9a is fluctuated more sharply than the potential Vpix2 of the second electrode 9b.

Then, the first electrode 9a is driven while the potential Vpix1 is maintained at the negative polarity, and the second electrode 9b is driven while the potential Vpix2 is maintained at the positive polarity. Then, the level of light leakage occurring In the second TFT 116b of the second pixel circuit 71b is equivalent to that occurring In the first TFT 116a when the first electrode 9a is driven while the potential Vpix1 is maintained at the positive polarity. Also, the level of light leakage occurring in the first TFT 116a of the first pixel circuit 71a is equivalent to that occurring in the second TFT 116b when the second electrode 9b is driven while the potential Vpix2 is maintained at the negative polarity.

Accordingly, in every vertical period, in each pixel portion 70, it is possible to suppress considerable changes in the potential difference between the first electrode 9a and the second electrode 9b caused by the polarity inversion of the first electrode 9a and the second electrode 9b. Accordingly, the voltage applied to the liquid crystal is not sharply fluctuated in every vertical period, and the occurrence of flickering can be prevented.

Thus, according to the above-described second embodiment, high-quality image display can be achieved.

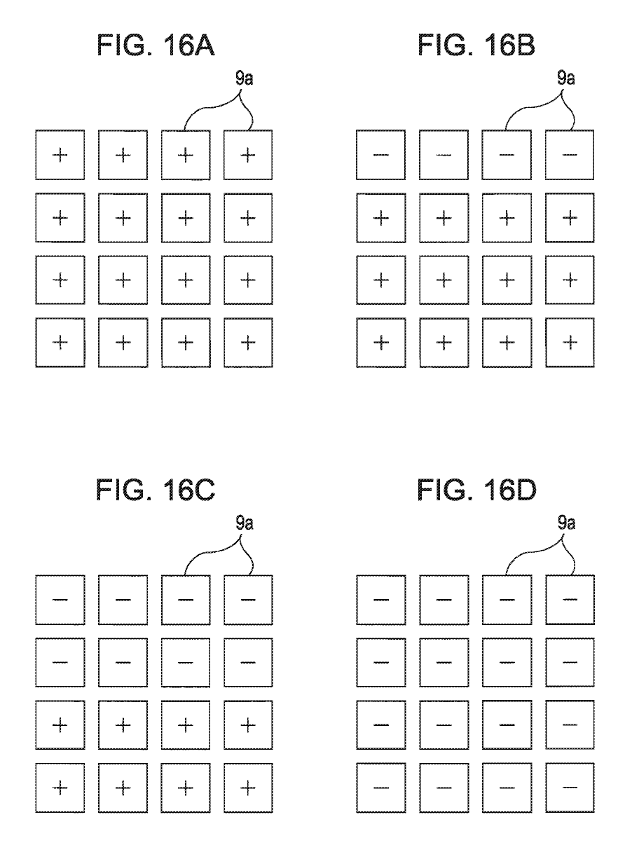

In the second embodiment, in the liquid crystal device, frame inversion driving may be performed. FIGS. 16A through 16D are schematic diagrams illustrating the frame inversion driving. In the frame inversion driving, in each of the pixel portions 70 disposed in a matrix in the image display area 10a on the surfaces of the first substrate 10 and the second substrate 20 facing each other, the potential of the first electrode 9a is inverted to the positive polarity or the negative polarity with respect to the reference potential in every vertical period, and the potential of the second electrode 9b is inverted to the polarity opposite to the first electrode 9a with respect to the reference potential in every vertical period.

That is, after the lapse of a certain vertical period, in the pixel portions 70, as shown in FIG. 16A, the first electrodes 9a are maintained at a potential of the same polarity, i.e., the positive polarity (+), and the second electrodes 9b are maintained at a potential of the polarity opposite to the first electrodes 9a, i.e., the negative polarity (−)

At the start of the subsequent vertical period, Which is temporally continuous from the previous vertical period, as shown in FIGS. 16B and 16C, in every horizontal period, on the basis of the first image signal V1, the polarity of the first electrodes 9a along the first scanning lines 112a is line-sequentially inverted to the negative polarity (−). Meanwhile, on the second substrate 20, on the basis of the second image signal V2, the polarity of the second electrodes 9b along the second scanning lines 112b is line-sequentially inverted to the positive polarity (+), which is opposite to the polarity of the first electrodes 9a, in synchronization with the polarity inversion of the associated first electrodes 9a.

After the lapse of this vertical period, as shown in FIG. 16D, the first electrodes 9a are maintained at the potential of the negative polarity (−), while the second electrodes 9b are maintained at the potential of the positive polarity (+).

Accordingly, the synchronization of the polarity inversion of the first electrode 9a and the associated second electrode 9b can be controlled individually for each pixel portion 70. Additionally, in each pixel portion 70, in every vertical period, it is possible to suppress considerable changes in the potential difference between the first electrode 9a and the second electrode 9b caused by the polarity inversion of the first electrode 9a and the second electrode 9b.

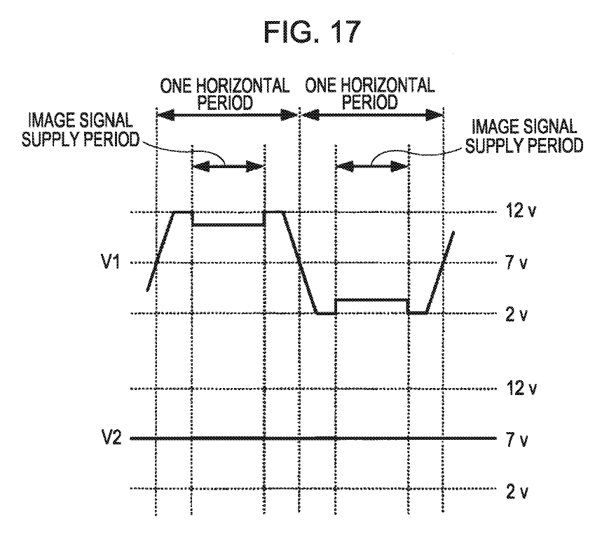

Alternatively, in the second embodiment, in the liquid crystal device, instead of the polarity inversion driving similar to the common-electrode-potential switching driving, the following type of polarity inversion driving may be performed. FIG. 17 is a waveform diagram illustrating the first image signal and the second image signal according to another type of polarity inversion driving. As in the operation discussed with reference to FIGS. 13 and 14, a description of the line inversion driving in the liquid crystal device is given blow by focusing on the pixel portions 70 corresponding to the (j−1)-th first scanning line 112a and second scanning line 112b and the j-th first scanning line 112a and second scanning line 112b.

Between two temporally continuous horizontal periods, in the first horizontal period, the image signal processing circuit 300 inverts the potential of the first image signal V1 to the high positive polarity (+) with respect to the reference potential, i.e., 7V, and also fixes the potential of the second image signal V2 to the reference potential, i.e., 7 V. In the image signal supply period, the potential of the first image signal V1 is adjusted with respect of the potential of the second image signal V2 to a value between 7 V and 12 V so that the potential of each first data line 14a can be adjusted.

With this operation, In the pixel portions 70 corresponding to the (j−1)-th first scanning line 112a and the (j−1)-th second scanning line 112b, the first image signal V1 of the positive polarity is supplied to the first electrodes 9a, while the second electrodes 9b are fixed at the reference potential based on the second image signal V2 in synchronization with the supply timing of the first image signal V1 to the first electrodes 9a.

In the subsequent horizontal period, which is temporally continuous from the previous horizontal period, the image signal processing circuit 300 inverts the potential of the first image signal V1 from the positive polarity to the negative polarity with respect to the reference potential while maintaining the second Image signal V2 at the reference potential. Then, in the image signal supply period, the potential of the first image V1 is adjusted with respect to the potential of the second image signal. V2 to a value between 2 V and 7 V so that the potential of each first data line 114a can be adjusted.

With this operation, in the pixel portions 70 corresponding to the j-th first scanning line 112a and the j-th second scanning line 112b, the first image signal V1 of the negative polarity is supplied to the first electrodes 9a, while the second electrodes 9b are fixed at the reference potential based on the second image signal V2 in synchronization with the supply timing of the first image signal V1 to the first electrodes 9a.

According to the polarity inversion driving discussed with reference to FIGS. 16A through 17, in each pixel portion 70, the current for driving each of the first electrode 9a and the second electrode 9b can be made smaller than the current required for driving the counter electrode 21 of the comparative example. It is thus possible to easily stabilize the potentials of the first electrode 9a and the second electrode 9b, and the pixel portion 70 can be driven at high speed.

If the second electrode 9b in each pixel portion 70 is fixed at a predetermined potential, as shown in FIG. 17, the potential difference between the first image signal V1 having the positive polarity and the first image signal V1 having the negative polarity becomes larger than that when the inversion driving similar to the type of driving discussed with reference to FIGS. 13 through 14B is performed. In this case, the power supply voltage for driving the peripheral circuits including the first data line drive circuit 101a on the first substrate 10 is increased. Thus, large breakdown voltages are required for various circuit elements, and the power consumption is accordingly increased.

Electronic Apparatus

The applications of the above-described liquid crystal device to various electronic apparatuses are described below.

Projector

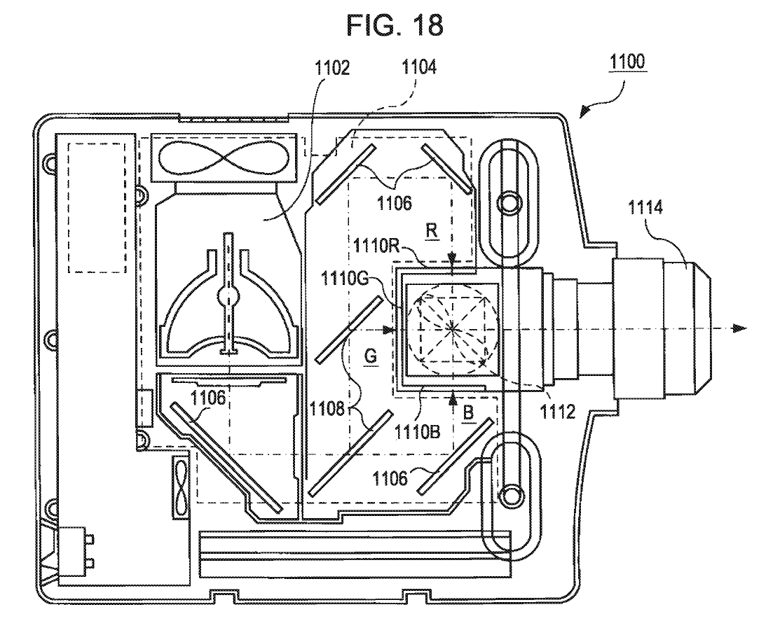

A projector using the liquid crystal devices as light valves is first described with reference to the plan view of FIG. 18, in a projector 1100, as shown in FIG. 18, a lamp unit 1102 including a white light source, such as a halogen lamp, is disposed. Projection light emitted from the lamp unit 1102 is separated into three primary colors, i.e., R, G, and B colors, by four mirrors 1106 and two dichroic mirrors 1108, which are disposed in a light guide 1104, and the R, G, and B color light components are incident on light valves 111oR, 1110G, and 1110B corresponding to the R, G, and B colors, respectively. The three light valves 1110R, 1110G, and 1110B are formed by using liquid crystal modules, each including the liquid crystal device.

In the light valves 1110R, 1110G, and 1110B, the liquid crystal panels 100 are driven by R, G, and B color signals supplied from the image signal processing circuit 300. The R, G, and B color light components modulated by the liquid crystal panels 100 are incident on a dichroic prism 1112 in the three directions. In the dichroic prism 1112, the R and B light components are refracted at 90 degrees, while the G light component passes direct through the dichroic prism 1112. As a result of combining the R, G, and B colors components, a color image can be projected on a screen through a projection lens 1114.

By focusing on display images formed by the light valves 1110R, 1110G, and 1110B, it is necessary that the display image formed by the light valve 1100G be horizontally inverted (mirror-reversed) with respect to the display images formed by the light valves 1110R and 1110B.

By the provision of the dichroic mirrors 1008, light components corresponding to R, G, and B primary colors are incident on the light valves 1110R, 1110G, and 1110B, thereby eliminating the necessity of providing a color filter.

Mobile Computer

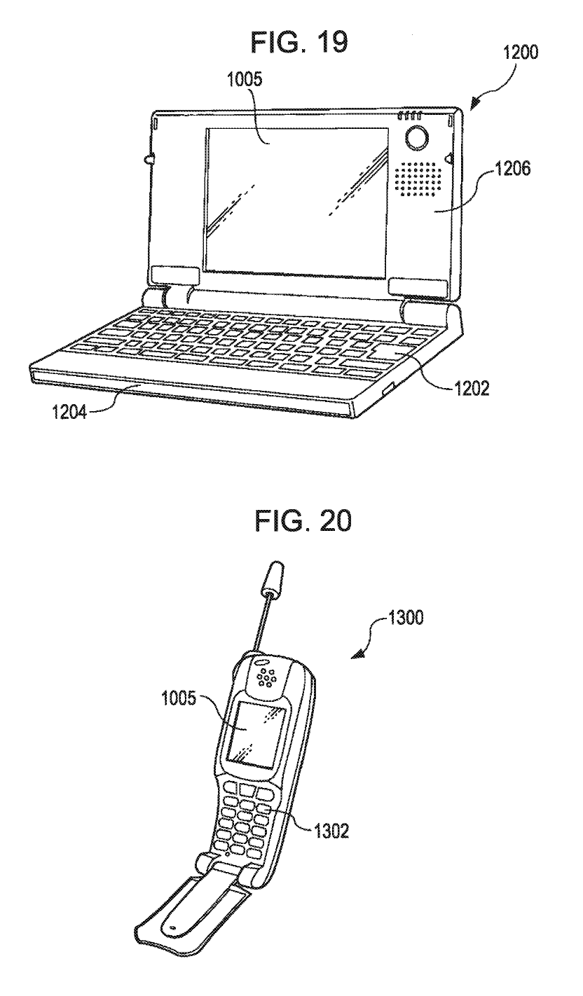

A mobile personal computer including the above-described liquid crystal device is described below with reference to the perspective view of FIG. 19. In FIG. 19, a personal computer 1200 includes a main unit 1204 including a keyboard 1202 and a liquid crystal display unit 1206. The liquid crystal display unit 1206 is formed by adding backlight to the back side of a liquid crystal device 1005.

Cellular Telephone

A cellular telephone using the above-described liquid crystal device is discussed below with reference to the perspective view of FIG. 20. In FIG. 20, a cellular telephone 1300 includes a plurality of operation buttons 1302 and the liquid crystal device 1005, which is a reflective type. Front light may be disposed on the front side of the reflective liquid crystal device 1005 if necessary.

The electronic apparatuses may include, not only the projector, the personal computer, and the cellular telephone, shown in FIGS. 18, 19, and 20, respectively, but also liquid crystal televisions, view-finder-type or monitor-direct-view-type video recorders, car navigation systems, pagers, electronic organizers, calculators, word-processors, workstations, videophones, point-of-sale (POS) terminals, and units provided with touch panels. The liquid crystal device can be used for those electronic apparatuses.

The invention is not restricted to the above-described embodiments, and various modifications may be made within the scope of the claims and without departing from the spirit of the invention. Electro-optical devices formed by such modifications and electronic apparatuses including such electro-optical devices are encompassed within the technical concept of the invention.

What is claimed is:

1. An electro-optical device comprising:
a pair of a first substrate and a second substrate between which an electro-optical material is held;
a first electrode formed in each of a plurality of pixel portions disposed in a pixel area on one of the first substrate and the second substrate;
a first pixel circuit formed in the pixel portion on the one of the first substrate and the second substrate and including a first active element that controls the corresponding first electrode;
a second electrode formed in each of the plurality of pixel portions disposed in the pixel area on the one of the first substrate and the second substrate or the other one of the first substrate and the second substrate, the second electrode being formed in association with the first electrode; and
a second pixel circuit formed in the pixel portion on one of the first substrate and the second substrate or the other one of the first substrate and the second substrate and including a second active element that controls the corresponding second electrode, the second pixel circuit being formed in association with the second electrode.

2. The electro-optical device according to claim 1, further comprising a signal supply circuit that outputs a first signal to be supplied to the first electrode and also outputs a second signal to be supplied to the second electrode.

3. The electro-optical device according to claim 2, further comprising a defective information storage unit that stores defective pixel data indicating a defective pixel portion among the plurality of pixel portions disposed in the pixel area,
wherein the signal supply circuit adjusts the second signal on the basis of the defective pixel data stored in the defective information storage unit and supplies the adjusted second signal to the second pixel circuit so that a voltage between the first electrode and the second electrode in the defective pixel portion is adjusted.

4. The electro-optical device according to claim 3, wherein the signal supply circuit supplies the adjusted second signal to the second pixel circuit in the defective pixel portion by replacing a potential of the second signal with a potential of the first signal.

5. The electro-optical device according to claim 2, wherein the first electrode is set to be a potential of the positive polarity or the negative polarity with respect to a reference potential by the first signal, and
the second electrode is set to be a potential of the polarity opposite to the polarity of the first electrode by the second signal.

6. The electro-optical device according to claim 1, wherein the second electrode is formed on the other one of the first substrate and the second substrate.

7. The electro-optical device according to claim 1, wherein the second pixel circuit is formed on the other one of the first substrate and the second substrate.

8. The electro-optical device according to claim 6, further comprising:
a first storage capacitor electrically connected to the first pixel electrode on the one of the first substrate and the second substrate; and
a second storage capacitor electrically connected to the second pixel electrode on the other one of the first substrate and the second substrate,
wherein the second storage capacitor, the second electrode, and the second pixel circuit are formed on the other one of the first substrate and the second substrate.

9. The electro-optical device according to claim 1, wherein at least one of the first active element and the second active element includes a thin-film transistor.

10. An electronic apparatus comprising the electro-optical device set forth in claim 1.
